(19) United States
(12) Patent Application Publication
(10) Pub. No.: US 2019/0259503 A1
(43) Pub. Date: Aug. 22, 2019

(54) METHOD AND APPARATUS FOR ENERGY CONVERSION

(71) Applicant: Eerin ROSENSTROM, Espoo (FI)

(72) Inventor: Eerin ROSENSTROM, Espoo (FI)

(21) Appl. No.: 16/086,889

(22) PCT Filed: Mar. 21, 2017
(86) PCT No.: PCT/FI2017/000005

§ 371 Date: Sep. 20, 2018

(30) Foreign Application Priority Data
Mar. 21, 2016 (FI) 20160069

(51) Int. Cl. G21B 3/00; G21G 1/12

(52) U.S. Cl. CPC G21B 3/002; G21G 1/12

(57) ABSTRACT

A method and apparatus according to the method for producing nuclear energy comprising a container (13) converting the material into a second with atomic reaction and transforming it into a reaction product comprising heat, particles, neutrino and/or electromagnetic radiation and electromagnetic radiation (2) relevant to material under the nuclear reaction transferring a single quantum maximum energy of 500 electron volts the radiation clement (12) for transferring energy to the material to be transformed that the targeting of the reaction products of the container to the radiation element is controlled by separating the container and the radiation element from each other. More than 1 nm sized microstructural (5) storage modes are used generating a coherent electromagnetic emission pulse (8) emitted by exciton polaritons vibration forms (7) for achive nuclear reactions to the necessary energy levels. A heat-utilizing apparatus such as a thermal power engine or thermoelectric generator, a radiation-utilizing apparatus, a apparatus for moving the object, and an industrial or power plant utilizing a method or a apparatus according to the method.

### SUMMARY

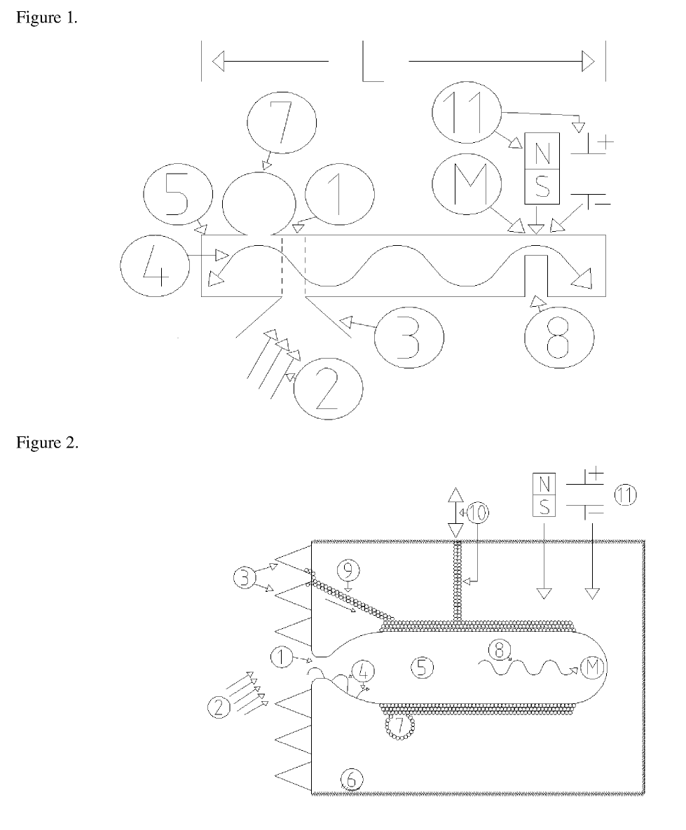

The following summary refers to FIGS. 1,2,3 and 4. The numbers are consistent between the figures.

A method for producing nuclear reactions is described here
A) provides (20) a long-wave electromagnetic energy (2) from the energy source (12);
B) charging (21) the energy storage medium (7) with energy (2) from the energy source (12);
C) releasing said energy (22) from the energy storage material (7) to the energy-absorbing reactant material (M);
D) Produces nuclear reactions in reactant material (23).

Nucleic reactions here mean a process where two atomic nuclei or that an atomic core and a subatomic particle (such as a proton, a neutron or a high energy electron) from outside the atom collides and forms one or more atomic nuclei that differ from the atomic nucleus (s) at the beginning of the process. The production of nuclear reactions means that a nuclear reaction occurs in the material.

An energy source (12) is here defined as any source of energy that can be used to charge energy storage material.

Examples include, but not limited to, radiation sources such as electromagnetic radiation sources. Examples of sources (12) of electromagnetic radiation (2) include, but are not limited to, incandescent and/or glowing surfaces, LED light sources, arc lamps, ultraviolet lamps, fluorescent lamps, gas discharge lamps, infrared lamps and/or incandescent lamps. Other methods of making electromagnetic radiation utilization are possible according to the invention.

Long-wave radiation (12) refers to radiation whose wave energy is between 500 electronvolts and 1/10 000 electronvolts. Long-wave radiation may be radiation with a wave energy between 100 electronvolts and 1/1000 electronvolts. Long wave radiation can be radiation by the wave energy is between 10 electronvolts and 1/100 electronvolts. Long-wave radiation can be radiation with a wave energy between 10 electronvolts and 1/10 electronvolts. Long-wave radiation may be in the range, which is a combination of the proposed upper and lower limits.

Charging (21) refers to energy collecting material. The material for which energy can be stored is energy storage material (7). Any material that can store energy can be energy storage material.

Release refers to the reason for the release of energy from the material. The material from which energy can be released can be energy storage material (7).

Energy absorbing reactor material (M) means a material capable of absorbing released energy and being capable of nuclear reactions.

The energy storage material (7) can be an energy absorbing material (M).

Examples of the energy storage material are nano materials, including but not limited to.

Examples of nano materials include, but are not limited to, powders, coatings, and layers having a nanostructure or a superatomic scale substructure. These super-atomic scale substructures / nanostructures and the means for their preparation are described later. Note that energy storage material (7) can function as an energy absorbing structure. An energy source can be a separate energy source (12). A separate energy source can be a source of electromagnetic radiation.

A separate energy source (12) refers to an energy source that is physically separated from the nuclear reaction outputs (such as heat, particles, and/or electromagnetic radiation) so that the nuclear reaction products produced by the nuclear reaction do not produce significant effects on the long-wave electromagnetic radiation of the energy source. The purpose of a separate energy source can be, for example, to limit the feedback between the energy source and the output of the reaction. A separate energy source can improve the management of reaction and reaction outputs. The particles produced by the reaction include, but are not limited to, alpha and/or beta particles.

Energy storage material (7) may be combined with one or more energy-absorbing structures (1, 3, 7). The energy-absorbing structure may comprise superatomic scale substructures. The superatomic scale substructure can be a nanostructure. The superatomic scale substructure may be an exiton-polariton structure (7). The energy-storing material and the energy-absorbing structure can be connected, for example, with one or more cavity-exiton structures that can be arranged as a channel (9,10) and/or surface plasmons (4) that can interact with cavity excitons that can act as energy storage material (7)

Energy absobifying structure (1, 3, 7) refers to any structure that is capable of absorbing electromagnetic radiation. This radiation may be long-wave electromagnetic radiation. Examples of such structures include, but are not limited to, surface structures (1, 3, 7). The surface structures may be bulging, cavities, pits. Said cavities or pits may be formed from exciton-polariton substructures. The exciton-polariton substructures can serve as energy storage. Said energy may be stored as an oscillation of the electron hole. Superatomic scale refers to a property where critical dimensions are larger than the dimensions of individual atoms. Energy absorbing structures can also be energy storage materials. The energy-handling macrostructure can also be the energy storage material. The energy-absorbing structure can also be an energy-handling macrostructure.

The stored energy can be released by an energy-releasing trigger (11). The energy-releasing trigger may be a change in the magnetic field and/or electromagnetic radiation source. The source of the change in the magnetic field can be, for example, a coil whose current changes. An electromagnetic radiation source may have a shorter wavelength than an energy source. Other sources of disturbance and ways of producing an energy-releasing trigger are possible in the invention.

Trigger (11) can mean any methods of energy relase fully or partially from energy-storing structures (7). Energy can be released, for example, from the exciton-polarition substructures (FIGS. 2, 3 and 4, number 7).

The nuclear reaction may be a fission reaction or a fusion reaction

The energy storage medium (7) may be combined with an energy centering, guiding and/or filtering macrostructure (1, 3, 5). The energy-centering, guiding and/or filtering macrostructure may be a protrusion (3), a pit cavity or a tubular structure (5). In said pit, cavity or tubular structure there may be opening (1) for electromagnetic radiation. Said protrusion (3) a pit, cavity or tubular structure may be means (1) to change the electromagnetic radiation to surface plasmon (light surface wave). Said surface plasmons can energize exciton-polariton cavities (7). The dimension of the perimeter of the opening in the pit, cavity or tubular structure may be of the same size as the energy source of the electromagnetic radiation source wavelength divided by pi (3.14159), a multiple or harmonic part of this chapter. The same size class here means a placement that may be lower than 20%, 10%, 5%, 2% or 1% lower than the reference value, and the upper limit may be 20%, 10%, 5%, 2% or 1% higher than the reference value.

The energy from the energy source may be, for example, the electromagnetic radiation (2) emitted by the electromagnetic radiation transmitting element (12) mentioned in Chapter 3. For example, the energy-storing material may be the vibration chambers of the surrounding material of the reactant material mentioned in Chapter 2., plasmothronics nanomaterial exciton type resonance chambers of the embodiment. For example, the energy-absorbing reactive material may be reactive material mentioned in Section 1 or the reactive material in polarized state. The nuclear reaction is equally atomic reaction. For example, a separate energy source may be in Chapter 3 mentioned radiation element (12) emitting electromagnetic radiation. For example, the source of electromagnetic radiation may be the electromagnetic radiation-emitting radiation element mentioned in Chapter 3. For example, the energy absorbing structure may be in the form of a surrounding material of the reactant material that is receive and target to electromagnetic radiation. For example, the superatomic scale substructure may take a shape corresponding to the plasmothronica nanomaterial exciton type resonance chambers of the reactant matrix mentioned in Chapter 2. or forms of the embodiment that receive and target electromagnetic radiation. The exciton polariton structure may be, for example, referred to in section 2. said exciton type resonance chamber of the embodiment of the reactant matrix perimeter plasmothronics nanotubes, a nano-structure cavity capable of storing energy. The energy-releasing trigger may be, for example, referred to in section 2. said reactive substance's permeability plasmothronics nanomaterial exciton chamber of the embodiment which is susceptible to changes in the magnetic field, or the exciton vibration chamber may dissipate its energy induced by electromagnetic radiation. The tool triggers the release of stored energy may be the transmission of electromagnetic radiation or the conduct of a magnetic field through the reacting material. The nuclear reaction may be, for example, a fission or fusion reaction. For example, energy processing may be the reflection, folding, filtering and/or phosphor conversion the electromagnetic radiation processing method or combination mentioned in Chapter 4. For example, the energy-processing macro structure may be a form in the surrounding material of the reactant material that filters, receives, or alters the energy of the electromagnetic radiation. For example, a pit, cavity, or tubular structure may be a plasmothronics tubular shape of nanomaterial, a nickel plate cavity, a protrusion (triangle/spike) (3). The release of energy as a pulse may for example be a plasmothronics nanomaterials method to extract the stored energy. For example, the coherent electromagnetic radiation may be plasmothronics nanomaterials the electromagnetic energy laser emission of simultaneously excised vibration chambers of the adjacent excitation vibration chambers, or laser radiation in general. Processing for energy sources may be structures placed electromagnetic radiation on the passage through which passage/reflection/refracting can be controlled. The processing can be controlled by way of example by computer processing of the control parameters. Chapter 6 describes ways of utilize the process of producing heat, radiation and / or particles.

1 Background

All the methods/devices reported by this invention are based on the phenomena already familiar to physics in chapter 1 and the refinements I have presented to the underlying phenomenon. They do not as far I know break any known phenomenon of physics or natural laws, although some of the endpoints may be contrary to the claims of modern physics and arguing, this invention teaches a detour along which passages of the impossible physics can happen in the world we know and it also explains why cold fusion Then the phenomenon that has been observed works well as it is in its nature. Further, it should be noted that if the cold fusion is possible, its reverse is also possible(fission). The reader should note that the description of the invention is written at the time of writing to the inventor about an unknown phenomenon around the present invention which forms a first part of the invention and is described in a more precise view of the activity of the micro-level material forming the second part of the invention. Thus, some of the explanation may be somewhat contradictory, but these points have to be interpreted among the phenomena of different scales, the smallest and most relevant events of the invention occur on a nanometric scale, which is typically within a range of less than ten light-wave lenghts including the change of electromagnetic radiation to the surface wave of electromagnetic radiation with other related phenomena followed by the substantial reduction in the physical size of the reaction environment, the increase in energy density and the greater quantum mechanical nature of the phenomena. The first older portion of the invention considers this to be of greater magnitude and tries to tell what is observed macroscopically.

Method and method for producing atomic energy comprising a container (13) for transforming the material to another by atomic reaction and transforming it into a reaction products comprising heat, particles, neutrino radiation and/or electromagnetic radiation and electromagnetic radiation relevant to the atomic reaction of materials with a maximum energy of 500 electron volts A radiation element (12) for transferring energy to the material to be transformed that the targeting of the reaction products of the container to the radiation element is controlled by separating the container and the radiation element from each other. Use a coherent electromagnetic radiation pulse emitted by the microstructure (5) inventory forms (7) for atomic reactions to achieve the necessary energy levels. A heat-consuming device such as a thermal power station or thermoeletric generator, a radiation-absorbing device, a device for moving a subject, and an industrial or power plant utilizing a method or a device according to a method. This application defines the method of producing an atomic reaction according to independent claims 1 and 2, as well as the device according to independent claim 7 for producing an atomic level reaction. The various embodiments of the method and apparatus are defined in the dependent claims 3-6 and 8. In addition, a heat-utilizing device according to claim 9, a device utilizing claim 10, a device for moving a subject according to claim 11, and an industrial or power plant according to claim 12 are defined.

The problems of prior art are the energy and material shortage, the difficulty of climbing the gravity well, an accelerating expanding universe. Energy price.

Explanation Content

Table of Contents:

Chapter 1 The Phenomena already Known by Physics in the Circle of the Invention.

Chapter 2 Methods for Utilizing the Invention
The steps needed to produce the fusion reaction method, the needs for that to happen:
2.1. A reactive material to be polarized in order to receive electromagnetic radiation. Radiation must cause the material to oscillate at a quantum plane at a suitable frequency, i.e., the radiation must be at the right wavelength for the oscillation frequency or the incoming radiation must be sufficiently highenergetic.
2.2 photon receiving and concentrating nanomaterials cavity ratio photon wavelength, antenna, standing wave, state of matter where the prevailing amount of radiation is wavelength essential energy quantums.
2.3 a photonic source isolated from the positive feedback of the reaction energy that transmits substantial amounts of the desired wavelength or wavelength to the reacting material to allow the reaction to be controllable/device scalable
2.4. The photon targeting structure to nanomaterials, if necessary filtration, the phosphor conversion
2.5 sufficient vibration for the amount of light emitted by the time-reacting material in order to high energy level, polarization, “short-circuit” only a few material units at a time absorb a large amount of radiation—high energy density in a small area.
2.6 utilization
2.7 continuous reaction/equipment maintenance/structures
2.8 safety equipment
2.9 control logic

Chapter 3 method for device
3.1 Radiator/Conversion/Filtration
3.2 Reflector/optic
3.3 reactor tank
3.4 nanomaterial
3.5 polarization, magnetic field if required
3.6 Reactive substance
3.7 Use of reaction results
3.8 Other equipment (control, wiring, tubes, shields)
3.9 use as energy source/transformation of substances

Chapter 1

The present physics is essential for understanding the invention.

Known phenomena: “electron capture, pair production, photofission, addition of radiation quanta”

“Electron capture”, “EC” or electronic capture. Physics knows this event as a spontaneous radioactive disintegration into a casualty, as well as actively caused by, for example. By colliding with accelerated electrons by material, or by high-energy photons (X-rays/gamma radiation). This typically occurs in a substance with a large number of protons in the nucleus relative to the neutrons. On the other hand, physics also knows instances where the atoms of atoms in other atoms have effects on this particular event, In certain beryllium isotopes chemical binding has been found to be effective. Chemical binding is known in interactions between physics electronic cores. Thus, modern physics proves that electronic capture is not just a matter controlled by the inner structure of the atomic nucleus. Still, modern physics feels that electronic capture, like other half-life reactions, is responsible for the four main weak interactions. This can be seen as a matter of contemporary physics that the structure of the atomic nucleus shell and the atomic core composition together affect how weak interaction changes the nucleus structure. The effects of an electronic shell on the phenomenon are the most powerful in a material of the nature of fermion, such as all matter that holds less than four elementary particles in an atomic nucleus (hydrogen, deuterium, tritium, He3), forces that are needed for holding are coming through weak interaction.

There is a derivative of a current physics event in which the hydrogen ions H, which is rotated by two electrons and where weak interaction detects an excessive negative pressure/charge in the electronic shell/atomic environment relative to the atomic core size/particle size, the weak interaction tends to correct the situation by converting the proton into a neutron by electronic capture, The attraction and the amount of charge in the environment decreases, thus weakening the negative charge pressure experienced by the nucleus.

This event can not happen spontaneously, and it is not known to occur naturally in itself because the common mass of the proton and the captured electron is less than the neutron produced, that is, the event requires an external energy/mass of 0.78 Mev from the atom in order to increase its probability of occurrence to the perceptible level.

“Pair Production, Induced EC, Auger Effect, Photofission”

In physics, many phenomena in which the single high-energy photon (gamma, x-radiation) of electromagnetic radiation provides atomic-level phenomena, electromagnetic radiation affects the material, and if the energy level is high enough, changes in atomic nucleus levels can also occur, with less energy-focused changes in electronic shell changes. Above 1.022 Mev levels can also result in the emergence of new particles apparently from scratch, meaning that the known formula E=mc² works in both directions. When the negative hydrogen ion is introduced by the photon, the energy is about 0.78 Mev in front of which its atomic nucleus becomes an electron capture phenomenon by converting the proton into a neutron. The generated neutron gets some kinetic energy if the amount of energy introduced exceeds the reaction threshold. If the reaction zone of the reacting ion contained a second atom such as a proton, the captive forces between them determine the direction where the excessive kinetic energy is directed towards the EC capture, that is, the events will go in the direction of the existing forces rather than against them, that is, the neutron born and the other atom in the chemical bond, Is directed towards it, leading to their combining and the release of the binding energy primarily to the energy of the neutrino and to the small amount of generated energy generated by the kinetic energy of the deuterium core in the ratio of the impulse mass/particles of radiation between the particles/with known equations.

If the energy of the photon does not suffice directly to produce changes in the nucleus plane, the energy can move into the nucleus or electron shells. If the energy level of the photon exceeds the maximum amount of energy needed to move the particles of electronic shells with a sufficient certainty factor, the energy of the photon can generate the kinetic energy of the chemical compound and then disperse it to the separate atoms of the compound which receive the kinetic energy of the photon quantum energy reduced by bond energy. The motion energy obtained from the photon is oriented in the direction of the prevailing bonds and if the energy obtained is not so large that it is able to overcome the rejection forces of Coulombs, they cause the particles to be separated from each other by dividing the pulse of motion energy relative to their masses. Thus, for example, about 0.6 Mev in the hydrogen molecule, the precipitated photon provides approximately 0.3 Mev protons with propagation speed. If the other part to the bond is a significantly heavier nucleus, such as nickel, a little more than 0.3 Mev energetic photon is sufficient to provide about 0.3 Mev motion energy protons whose kinetic energy is oriented in the direction of the third-party electron-extending atom (such as lithium, sodium , Aluminum, etc.) According to some data sources, the proton-litum fusion has a relatively high probability of about 0.3 Mev with energy. Thus, still relatively low photon energies make it possible to make the most varied proportional controlled proportions of energy that are particularly targeted, i.e., the method of reducing the breeding reactions by chemical bonding and thereby achieving a greater chance of nuclear hits than the probability of probability shown by the physics particle spraying methods tabulated values, so aqquire better energy economy. With tensile bonding forces, before the photon absorption can be determined the direction of the kinetic energy. The method works if the energy equally affects the electric field causing the coulomb forces of the atomic nucleus, that is, the absorbent energy must be surrounded by a substantially uniform atom of the reaction. Ununiform energy imports behave like the well known collision reactions nowadays.

For energy levels exceeding the limits of 0.3 Mev, 0.78 Mev and 1 Mev, it is thus possible to achieve simple fusion reactions, such as lithium protons, proton proton. The reactions may be very distinct among each other. The lithium protons reaction releases abundant energy as alpha particles. Through EC capture, the 0.78 Mev-level protons protons release very little, and the 1 Mev-level proton-protons reaction releases energy moderately as X-rays/gamma beams. These reactions form a good example of a variety of reactions, one that produces alpha particles, that is, essentially heat, the other through EC to produce matter and consume energy, even enabling the environment to be cooled to matter, and the third reaction produces positron radiation which, when braked to the nickel atom, mainly produces X-rays, Farther outside the reaction environment. It is also to be noted that if the reaction chains are carried out, pumping/triggering energy can be fed in the ratio of reactions, e.g., H2->D, D2->He, 2:1, whereby 2/3 time/energy is fed at 0.78 Mev level and 1/3 1 Mev level. This energy chain naturally requires the binding of a deuterium molecule to a third atom to allow the probability of occurrence to the alpha particle, leaving the reaction energy to require a partner of an impulse mass, e.g. nickel atom, to release the reaction energy.

It is also possible to make the reaction step by step with the partner atom, i.e.,

Ni58+H->59Cu, 59Cu->59Ni+e+, 59Ni+H->60Cu, 60Cu->60Ni+e+

In the aforementioned chain, 59Cu and 59Ni are not bosons. If the chain is to be considered as pure boson, then there must be a hydrogen deuterium reacted with nickel:

Ni58+D->60Cu, 60Cu->60Ni+e+

In hydrogen, reaction chains can continue to bromine—krypton depending on the reactor temperature, while krypton noble gas drops out of the reactor, even after leaving rapidly decay to selene-arsenic isotopes. However, they can be restored to further reactions, if necessary. There are also significant positrons coming from the half-life of the reaction products, capable of delivering 511 ke and their kinetic energy (typically a few mega-electron volt+neutrino). If the reactor is kept relatively cool, then the nickel-less material is zinc having a plurality of boson-like isotopes, e.g., 64Zn, titanium and iron, there are also stable boson isotopes, even lighter and relatively electronegative magnesium whose boson-like isotopes are richly represented on earth-exploitable occurrences. It is also important to note the lithium isotopes, of which lithium 7 constitutes the majority of the occurrence. Lithium 7 or a lithium hydride formed therefrom is possible by the reaction of hydrogen EC to a neutron, whereby the neutron is formed by the formation of lithium 8, which is half almost immediately into two alpha particles. The detected lithium levels in the universe are essentially a blow to the theorem lower, so lithium may well be a usable reactive material that somebody has used in substantial quantities.

Summing the Quantums

This point goes to the gray field of modern physics, apparently there are some claims/theories/predictions that exist that is possible. Certain experimental results are unknown, uncertainties can be found. Thus, it is possible that, if within a particularly short period of time material magnitudes arrive to several quantums, quantum physics processes them at the same time and the reactions can take place with their aggregate energy. This so-called event horizon it is possible to increase the atomic nucleus to the larger proportions because the interaction of electromagnetic radiation takes place through the electromagnetic and magnetic forces to the atoms, and these forces act far from the atomic nucleus, if not neutralized by the electron shell. In physics it is well known that neutral atoms only have very little influence on electromagnetic radiation with a higher wavelength of atom, but instead polar compounds or ionized gases (eg plasma) are absorbing electromagnetic radiation, in other words, they do not pass through the light.

That is, if an electromagnetic radiation field is introduced, an ion has an electric field extending far from the atomic nucleus. If this field is strong enough to reach the distance to the wavelength of electromagnetic radiation, it can function as a conceptually antennas. Which interacts with the electromagnetic radiation associated with the volume at that time. The electromagnetic wavelength of which is approximately at the tuning frequency of this antenna and at approximately the right stage by increasing this field energy by absorbing. Taking into account the speed of the light and the distance of the field from the atomic nucleus, the information/energy level arrives at the atomic nucleus only at the light velocity. That is, the accumulating energy has at least time to sum up from the farthest point of the field to the atomic nucleus at the time travelling speed of light. In other words, the ionic atom is capable of receiving electromagnetic radiation from a wide area so that the energy of the moments of vibration within the volume of the reception area is summed together and reactions of the atomic level can occur with the sum of the sums of energy summed. All the atomic phenomena known in the physics described above can thus occur with the energy of the summed quantas. For each element and combinations thereof, it is most likely that there are favorable vibration frequencies with greater probability of occurrence, but can be made outside of the preferred frequencies.

1 Reactant Material

The material consists of different atoms, which are called elementals. There are 92 known stationary elements and numerous stable and radioactive isotopes for them. According to the theory of relativity, the materia is energy according to the formula E=mc². As the number of elements increases, atoms accumulate more elementary particles called protons, neutrons and electrons. At the same time, the mass of the elements increases, but it grows less than the mass of the elemental structure particles detached. It is possible to combine (fusion) with light elemental elements heavyer while releasing energy or fragment heavier elements into medium weight by releasing energy (fission). In this method, the reactive material consists of atoms that can be combined and degraded by producing energy and the energy/particles released in the reaction chains to utilize the elemental element to be converted into another element when needed, if necessary. The reactive material are atoms, as a moustly lightweight elements.

It is advantageous for the material surrounding the reactant material to be medium heavy so that it does not substantially change the reactions products. Fission reactions exclude previously known and utilized U232, U235, Pt239 chain reactions wherein the radiating element and the reactive element are the same substance and wherein the reaction is controlled by the production of particles by slowing down by absorption by removal, and by the high-energy particle accelerator fission/fusion reactions, further known or suspected nuclear reactions Radiation-producing devices in which the reactant material is substantially connected to the radiation-transmitting element such that reaction outputs such as heat or heat-emitting radiation are coupled to the immediately-responsive material. The fissile materials suitable for the method include elements with the following terms:

194<Z<211, Z²/A>=36

In the present invention, the reactant material must be brought or must already be in a state called polarization, the other word having electrically charged halves so that the reactant material can affect electromagnetic radiation directed on it. Polarization can be caused by external electric fields or by bringing the charged particle, ion, to the reactant material, or allocating charge-bearing radiation. In a microscopic environment, the most energy-efficient way to produce polarization is an ion close to matter. The ion may be positively or negatively charged. If the reactant material is composed of the material of the first, second or third major group of the periodic system, the positive ion is more useful because it does not so easily form the chemical compound with the reactant material. The higher the electronegativity of the near ion, the more efficient it is to create a local electric field and hence polarization. The ionisation agents suitable for the 1-3 reactants of the main group are alkali and alkaline earth metals (e.g., Li, Cs, Na). Typically, the electronegativity value must exceed 1.0 so that the necessary polarization is formed on the reacting material. If the reactant material is part of the fifth, sixth or seventh main group, polarization is most efficiently produced with the most electropositive substances (F, Cl, I). For polarization of substances in the fourth major group, both polarization and electropositive or negative agents can be produced. For the polarizing agent it is advantageous that it does not form a pooled chemical compound with the reactant material. The reactive material can, of course, consist of a chemical compound which may be polarized or pooled. The responsive polarized material has a vibration frequency or more that it is able to efficiently receive the electromagnetic radiation quantums. The wavelength of the electromagnetic radiation must be such that it will resonate the receiving material at the quantum level.

Quantum-level resonances typically discharge relatively quickly to matter in less than picoseconds, typically warming up the material, although other phenomena can be detected such as electron dissipation as well as the kinetic energy of the material. At the frequencies characteristic of the material, the resonance duration may be even longer than nanoseconds. In the method, it is advantageous to operate in the long range resonance frequency range.

If quantums of electromagnetic radiation is produced at a sufficiently short time intervals at a sufficiently short intervals of electromagnetic radiation quantum at a material-favorable frequency so that the resulting resonance does not have time to dissipate before the next quantum arrives, the quantum energies add to each other, extending possibly the resonance duration and when resonance release, releasing the energy of all quantums at one time. If the sufficiently dense quantum flow affects the reactant material for a sufficiently long period of time, the energy of millions of quantums can sum up in its release to such an extent that it is sufficient to cross the Coulomb's electrical forces and cause the atomic nuclei to converge into a heavier atom. Summed energy can also result in the dividing of heavy atoms into lighter atomic nuclei or particle formation that can further cause nuclear reaction. If there is a mass difference between the reactant material and the original unreacted material, the missing mass is released in the reaction as energy and/or particles and is therefore usable. From the point of view of the reactions, the resonance of the material is advantageous for it to last for a long time and its range of effects extends as far from the atomic nucleus, so that the density of electromagnetic radiation quantums for the summation does not rise to a impractical high.

In the material to which charge-bearing particles move around, the forces of Coulomb cause known resonances such as

Feshback, R-matrix theory/shape resonance+Gailitis extensions 1963. Gailitis resonances are said to be particularly long-lasting.

2 The Surrounding Material of the Reactant Material

In the vicinity of the reactant material, it is desirable to introduce a material having forms in which the reactant material can settle. For this surrounding material, a small particle size, nanomaterial, is advantageous for some method. From the point of view of the reactions, it is preferable that the material in the vicinity of the reactant material has shapes that can receive and target the electromagnetic radiation quantums in the reactive material in the wavelength range in the resonant frequency range of the reactant material or where the reactant material is capable of efficiently receiving energy. It is advantageous for a useful surrounding material that it is capable of packing and maintaining a relatively immobile reacting material during the reactions, especially just prior to the actual reaction of a rich electromagnetic radiation impregnated environment during the resonance excitation period, where it would otherwise be typical that the radiation quantums absorbing material for thermal movement and radiation pressure (panderomotive force) Because of that, it quickly moves to another location. For the forms of the envelope, it is advantageous to form cavities of a size that is suitable to form strong standing waves in the cavities to react to the reacting material at a preferred vibration frequency. For the top shape of the open ends of the cavities of the surrounding material particles, it is advantageous to be able to collect and concentrate the electromagnetic radiation quantums within the bigger area of the cavity opening to maintain/strengthen the resonance state of the standing waveform present within the cavity. Particularly preferred is if the shape of the open end prevents the standing wave escaping from the cavity. It may be advantageous for an surrounding material that an electronegative material is placed in the cavities to induce the polarization required for the reacting material, to provide or remove the electrons required for the reaction itself, to the direction of the reactions to control the reaction, and possibly to take part in the primary or secondary reactions of the reactant substance. The amount of free electrons in the reaction environment has an impact on the pathway of potential reactions as seen from 1/1H (p, e+ye) 1/2D, 1/1H (p, ve) 1/2D reactions. By controlling the amount of free electrons, parallel reaction paths can be guided to the happen in the desired direction.

From the point of view of a functional entity, the nano-grade surrounding material may be advantageous as having other frequency standing-wave waveform formations, whereby the reaction products of the original reactant can pass to their resonant cavity forms and react further to the third reaction products. The surrounding material tuned to the different frequencies can also be mixed with each other or form different reservoirs of permeable zones in the reactant material container.

The amount of reactant material can be adjusted and thus affect the amount of reactions taking place. Gaseous reactants simply by adjusting the gas pressure. However, in pursuing a good energy balance, the amount of reactant material should be maintained at such a high level that the majority of the surrounding material cavities have the necessary amount of reactant material for the reactions and packing, so that electromagnetic radiation containing the energy to be transmitted will not be lost. If, in a reactant material, oscillation caused by electromagnetic radiation would have a physical displacement in nature, would result in a denser amount of material with higher frictional losses and hence in reducing the amount of reaction deterioration. In the experiments, the increase / acceleration of the reaction by increasing the gas pressure of the reactant material is contradicted by physical displacement vibration theories (as described in WO2013076378 electrostatic displacement, hence outside the scope of this invention). As the gas pressure of the reactant material increases, the increase in power is due to the better filling of the cavities of the surrounding material, whereby the material receiving the electromagnetic radiation energy is physically better packed in the receiving position in a preferred physical location, for achieving the necessary high energy levels for the reactions and in possible further reactions of the reaction products. In the alternative, after the reactions occur, the pressure is relevant to the time to be recharged with the reactive material within the reactive element. The claim can be experimentally determined by the standardized amount of electromagnetic radiation, in the layer of nanomaterial applied to a sufficiently thin layer equipped with an effective heat-regulating arrangement to keep the temperature of the nanomatrix constant, despite the acceleration of the reactions. In this environment, the rate of reaction rates depends on the gas pressure of the reactant material only up to a certain maximum limit, after which the addition of gas pressure no longer substantially accelerates the reactions. In this mode, the operation is potentially the most energy-efficient because as little electromagnetic radiation is left unused. Naturally, the energy-efficient surrounding material does not absorb energy from electromagnetic radiation, transforming it into heat, so it is a good electrical conductivity/reflective surface for those parts that do not function as receptive and cavity-orientated parts.

Powder form surrounding material particles also have the benefit of scattering electromagnetic radiation from the surface layer, making the reactions even deeper than the immediate surface layer.

The surrounding material of the nano class can be considered in the magnetic field. The magnetic field may be constant or variable. The variable magnetic field can be used to heat nanomaterials.

The polarized reactant material may be directed to the magnetic field, thereby enhancing or weakening the interaction of the quantums of electromagnetic radiation with the reactant material and influencing the rate of occurrence of the reactions.

Some of the applications of the method to the peripheral material have the advantage of having an abundance of surface area, i.e., it consists of particles of the nanoclass, and surface forms and cavities are preferred for the desired radiant frequency.

In the absence of the presently preferred manufacturing methods or the use of known manufacturing methods to produce more specific desired forms, for example, from the optical semiconductor components, it is sufficient to be useful from the viewpoint of the usable method to maintain a nanoscale material having a large surface area but sufficiently large enough to allow it to form a diameter/length advantageous resonator structure and utilizes a relatively non-ideal method for the best possible/energy-efficient forms including an oxidation/reduction period for high-surface material—in this case, a large part of the emerging form is not operative in the method but a small part is sufficiently functional and because large surface forms To countless many, the volume unit develops enough of a sufficiently effective shape resonator Unit so that the surrounding material is substantially useful. The quantity replaces quality. It is still to be mentioned that the poor side of fine-grained powdery surrounding material has a deteriorated heat conduction, a high sintering of solid long before heat melt, and the adverse health effects of many fine powders, so the preparation of the surrounding material with the improved features described in the invention on their basis can not be considered to be particularly inventive.

For a long period of time in a uniformly functioning procedure, the surrounding material is advantageous that it does not take part in the reactions as it changes in them while also losing any mechanical/chemical properties. For example, the nickel isotope 62, which is known to tolerate yields that are unchanged from the reaction, are suitable for the surrounding material. On the other hand, if one embodiment is considered to be advantageous to produce from a less valuable surrounding material and the reaction products produced by the material reacting during use to alter it as a more valuable material, it may be advantageous to use a surrounding material that changes during use. Such surrounding material may be, for example, iron isotopes which, by reaction, become nickel isotope 62. Suitable surrounding materials include at least metals of the iron group, magnetic materials, and possibly noble metals such as palladium, gold, silver. It overcomes almost all of the materials that can be used to manufacture surface shapes suitable for receiving the desired radiation frequency and which produce sufficiently strong, energy-efficient standing waves to which the reactant material can be placed and, if necessary, polarized. Of course, different materials can be mixed with each other to achieve a better end result. The nanoscale particle size is not necessary to utilize the method, with the larger particle size less energy-efficient applications,

An embodiment can also be made in which nanoparticulate surface structures with appropriate cavities for providing a stationary waveform at a desired frequency, as described in the invention, are produced in the sheet body.

Such plate-like constructions may be relevant to the deeper study of the phenomenon, or in applications utilizing the charged particles produced by the reactant material to produce direct electrical energy.

The cavities in the planar structures can also be directed in the desired direction, whereby reaction outputs such as charged particles can be utilized more efficiently. The necessary hollow structures can be produced by, for example, etching with gaseous/liquid substances, by changing the surrounding material structure of the perimeter surface, for example by oxidation/reduction, by producing the same or another material on the surface or the entire surrounding material by condensing the gaseous materials, reactions in liquid substances, which may or may not be powered by an electric current, by crystallization. All of the aforementioned methods may be related to the use of radiation-sensitive material by the said exposure mask in one or more phases, The manufacturing steps may also include removal of any of the aforementioned portions or depletion of the substrate material by the above-mentioned techniques, or mechanically machining by strong electromagnetic radiation or electron stream pulses by vaporizing the solid material, In which the paths of the beams may have such-named exposure masks and optical lenses/reflectors centering/controlling rays, including magnetic and electric fields, which may also affect the manufacture of material from any of the manufacturing stages. Combinations of all of the aforementioned manufacturing methods whereby the material can be used to create the necessary surface formulations/cavities for the process and, where appropriate, to place polarization-producing materials or structures of larger size to generate the necessary electric field for polarization.

The surrounding material cavities also form an electromagnetic radiation filtering structure whereby the harmful frequencies of the reactions are filtered outside the reaction environment or, at best, their energy is converted to a preferred wavelength. The so-called Standing waveforms work efficiently only in the narrow frequency range at the resonant frequency. This frequency is influenced by the responsive material in the structures in question and by the number of known electromagnetic radiation propagation speeds. This phenomenon is useful in an energy-efficient reaction environment, reacting material sufficiently filled surrounding material the reacting environments reach the frequency range that is used to receive the radiation emitted by the electromagnetic radiation source as the energy of standing wave, when the excitation frequency of the emptier cavities is outside the useful frequency range, so they do not emit the energy of the electromagnetic radiation itself but reflect it for use in other reaction sites.

Surrounding material microscopic events viewed popularize for a larger time scale as pico a second class. When the resonant cavity is filled with a reactant material, the cavity resonance frequency changes. If an electromagnetic radiation is directed to the cavity at the frequency characteristic of the cavity. The formation of standing wave may form in the cavity. Where considerable amounts of energy can be stored in the standing wave. The reactive material in the cavity is neutral/un polarized. So it is generally not affected by electromagnetic radiation. But if there is an ionized substance in the cavity, such as an alkali metal, it can occasionally cause polarization in neutral matter. The phenomena known as the Feshbach or Gailitis resonance states that may be describe the invention require the charge carrier to move. Resonance is caused by the forces of Coulomb and a moving charge carrier. In dense capillary phenomena packed in the reactant material physical movement does not happen very easily, there ofcourse can be exclusion of the phenomenon and if motion is enough can the resonance state to evolve. Whereby the single resonating particle of the large number of material to be transformed start receiving electromagnetic radiation energy. Acts as a so-called short circuit absorbs the energy of a standing wave from a wide area—at the speed of light. Whereby very high energy states can be generated as a resonance state in smaller particles/forces at the atoms affecting the Coulomb fields. There may born a particle pair. In densely packed material, it is possible to get the charge carriers to move by producing a magnetic field in the material. Best variable field momentarily. At a frequency that is sufficiently sparse. So that the necessary amount of energy can accumulate in the shape of standing waves. But short enough to avoid unnecessarily wasting energy in the extra amounts of the reaction, to lose losses. The naturally advantageous fluctuation frequency must be determined by the amount of electromagnetic radiation to be accumulated. The more rapidly the surrounding material forms reach the energy level at which the dissipation is advantageous. Then more rapid fluctuation frequency. The magnitude of the magnetic field should also be adjusted to suit, so that only the individual/few charge-makers will float. So too many parts of the substance to be changed do not get into the vibration resonance. In any case, energy-descent points will develop too many. Whereby the individual energy levels do not rise sufficiently high for the necessary reactions. The reaction slows down/stops and the energy of the electromagnetic radiation is lost to waste heat. The amount of charge carriers can also be adjusted. I.e. by controlling the amount of specific electronegative or positive substances. The magnetic field also has an effect on the behavior of smaller atomic particles, so the effects of the magnetic field can direct the reaction flow or reaction yields.

Changes in the magnetic field can move the charge carriers. May change the unit of matter to oscillation. Whereby the energy stored in the standing wave is discharged from its trigger. The active magnetic field of the reactant material can thus affect the energy levels, which react at the reaction times in the reactant material. That is to say, it can be used as a means of controlling potential energizing reaction paths. Contorolling reactions as a stop mode. Control reactions can also influence reaction yields. Such as controlling charged particles for better utilization.

The necessary reaction here is to combine atomic nuclei with each other. Divide it into two or more nucleus, particle/radiation transition to the atomic nucleus. Creating atomic nucleus metastabile states. Known as a meta-stable atomic nucleus in the foreign language, and in the literature, the letter “m” followed by the mass number. Change the name of the atom called “spin number”. Thus changing the nature of matter from fermion to boson or otherwise. “Required Reaction” does not, as such, refer to changes in electron shells already known to science and the relatively low energy electromagnetic quantums generated by their recovery. Even if they can be produced by the method described by the present invention. Given the scale of the current science and the limited time available resources that I refer to relevant publications I did not find any. They can still be found. Any publications that may be found are unable to produce meaningfully useful “necessary reactions”. Also consider the abundance of publications associated with atomic nuclei. It should be noted that although some of them may have multiplied features of the invention. None have worked so far in industrial use. Or any reaction of the events is not explained in the manner described herein. The method of the invention or the modified material may be used as a weapon/weapon part. To produce high-energy energy/particulate emissions.

Physics knows the phenomenon of photofission. Where the high-energy quantum of electromagnetic radiation, mainly the gamma radiation, causes changes in the atomic nucleus. The energy levels required for electromagnetic radiation are at least several mega-electron volts, so that atomic level changes occur. Physics also knows the phenomenon of “pair production” from which the simplest electron+positron pair needs 1022000 ev quantum energy to the minimum. This invention describes a method by which similar and still unknown physiques with similar electromagnetic radiation energy transition to atomic nuclei can be produced by a very low-energy, 0.00000124-12,4 ev electromagnetic radiation. By directing a very large number of small energy quantums into the range of the atomic nucleus within a very short period of time. Whereby the energy of the quantums is summed up and the processes at the nucleus occur at the summed energy level.

A particularly efficient standing waveform storing form capable of discharging its energy in a very small period of time can be made by coupling the resonator chambers formed in the tubular space of the standing wave having some resonance frequency corresponding to the desired wavelength, i.e., microwaves in the resonator chambers at about eighth part of the wavelength (1/4pi). The oscillation of the resonator chambers can be directed to the magnetic field.

The reaction surrounding material is characterized by:

Too small wavelength—too small/accurate oscillation structure, insufficient energy to store volume, too much wavelength—too large shapes, individual quantum energy low, size so large that during the existence of vibration enough enough quantizes can not be absorbed into the material unit before energy dissipation, Problem, momentarily producing polarization. Thus, even though the energy of the electromagnetic radiation of the electromagnetic radiation used may be between 0 ev and 500 ev, the area of 50 to 500 ev is so fine-structured that the forms required for the manufacture of the known material can not be efficiently deposited in order to store the energy of the standing wave energy in necessary quantities to produce atomic-level reactions, may be impossible. In addition, chemical changes in the material causing the area in question are already known in the art. If the investigation reveals that a technique known to cause less than 500 ev radiation element to cause atomic changes in the electromagnetic radiation range 124-500 ev, this area may be excluded from the scope of the invention, further in this case, in order to achieve sufficient inventive energy, the energy range 12.4 to 124 ev To exclude, if applicable, 6.2 to 12.4 ev, potential for exploitation of the invention 0-500 ev, 0-124 ev, 0-12.4 ev, 0-6 ev and if it becomes apparent that 0ev electromagnetic radiation is unable to carry the necessary amount of energy or its The required structures can not fit into our home planet, zero (0 ev) can be replaced by, for example, 0,00000124 ev constructions in the above-mentioned energy regions with an effective wavelength class of less than one meter. It has also been suggested that the hydrogen ion absorbs electromagnetic radiation within the range 0.75-4 ev. The invention is also characterized by the fact that a relatively low power radiation element of instantaneous power can provide nucleus level reactions. With very high power laser sources, they have been trying to get tens of years out of unsuccesfull, but because high performance 1TW pulse laser devices have been susceptible to fusion reactions, very high power laser sources can be excluded from the invention and stay less than 1 GW laser performance.

Nanomateria in the Vicinity of the Light—Plasmothronics Manomaterial:

When the wavelength decreases to the ambient light area of 3 to 0.1 um, the standing wave storing shape can be made into a particularly small-scale nanomaterial using a science field known as plasmothronics where electromagnetic radiation passes at the interface between the conductor and the dielectric surface, while slowing down and physically shrinking significantly. In this case, the surrounding material of the standing wave shape shrinking is fairly short typically 2-10 wavelengths, the resonance chambers can be shrunk even more, up to a hundredth of the wavelength and thus allow them lot to occupy per a particularly surface area. The nanoscale also comes with some limitations, the cavityform having a standing-wave is then confined to tubular because the sharp corners are not beneficial for the function of the phenomenon. Also, be aware of the radius of curvature to absorb optimum energy as the impact angle affects the energy transfer to the vibration chambers. Resonance chambers are a phenomenon known as exciton, in which the electroncloud or electron hole circulates at the vibration frequency along the surface of the chamber. It can be popularly called/compared to the optical capacitor-coil as an oscillation circuit, though it has some quantum-level properties that are not noticeable in traditional LC circuits of the larger scale. If these excitement-type resonance chambers are sufficiently close to interacting with each other, they may also be partially open to each other in a network-like structure, whereby they phase into the same phase with each other and have a high energy density per volume unit. Such a exciton chamber is somewhat sensitive to the magnetic field, the field affects the spin of the electron. Induced by magnetic field, a chamber can vent the energy of a coherent photonic blast, the vibration chamber can also discharge its energy into electromagnetic radiation or induced by it. The tubular shape having the actual standing wave motion is advantageous when its two ends reflect the radiation back with the lowest possible losses. Such a shape may be a rounded tapered shape at the outwardly directed end, a small taper, i.e. the open end is slightly curved and the solid end is circular. The loss of the ends may also be reduced by dielectric material. Further energy storage per unit volume can be increased by filling the forms with a higher dielectric agent than the vacuum, gas pressure can also be increased. The Exciton style vibration mode applies to the typical characteristic frequency of the material, for example, with nickel it is at the same frequency as about 630 nm light (red light, some sources exhibit a characteristic frequency of about 450 nm, possibly with nickel having a number of favorable spikes). Nickel has a characteristic frequency curve that is broad, instead gold, which also has a 630 nm approximate frequency spike like.

In this embodiment, the broad characteristic frequency is advantageous as it wastes less energy outside the optimum bandwidth, i.e. the energizing radiation does not have to be so accurate at wavelengths. Several characteristic frequency peaks can allow doubling of a single vibration energy. Generating energy from the outside To form a chamber to iniate the reaction. The ongoing reaction may produce at least part of its energy required for reaction deliveries. In the chamber, energy can be supplied by an external source of electromagnetic radiation, one optima is close to the specific oscillations of the frequency range near characteristic frequency, for example, nickel red light is effective. In the case of a standig wave chamber or a nanoscale, the tubular chamber of the surface waves is open to the outside of the opening 100-200 nm which has been found experimentally and theoretically that electromagnetic radiation is effectively capable of forming the surface waves (surface plasmon polariton). It may be that the optimum opening size can be found as a function of the wavelength according to the ¼ wave antenna theory by dividing the wavelength with 4*pi (about 7.98), or one of its multiples (¼ pi about 50 nm at 630 nm radiation). I have not found any experimental studies where The size would have been tried with nickel so I still want to leave open the ¼ antenna works even better than the results of the research only 4/4 wavelength antenna size that has been found to work at least sufficiently well. One theoretical calculation would suggest that the 4/4 size would be the most effective. The shape of the vibration chamber in spherical form has been experimentally studied and calculated theoretically. The alleged recipes that operate in the subject area of the invention produce nickel processing methods, resulting in tube/tubular structures. In addition to the shape of the spherical oscillation chamber, the tubular 1-2nm diameter form can thus be effective, with an effective shape, for at least accounting a limited surface-area. As the light changes to the surface wave of light, its wavelength and propagation rate drop considerably, so the volume required for the same amount of energy shrinks by a decade perhaps even at some, so the structures previously shown at lower frequencies shrink in the same ratio. Efficient vibration chamber diameter drops to a few nanometers. The chambers are synchronized to the same oscillation stage and the boson, by its nature, can even form a condensate together. Which may result in superfluid and, in certain cases, superconductivity properties. They do not seem to me to be necessary to carry out the things described in the invention, only those things that can help in the production of particularly high energy states, to produce high energy coherent gamma rays which are necessary for the communication between the stars or in the interpretation of the modulation of messages received by high-energy gamma rays arriving here Absorbing the corresponding matter into the structures by shedding their energy. Gamma ray transmission when it is the most obvious way in which advanced civilizations communicate, a civilization operating in a primitive technology is not capable of receiving, only the material produced in this invention can receive the energy of gamma radiation, which may well be able to interpret its modulation. This apparent fact will only arise when this invention has its features available. That is, most obviously we can join the interstellar gammaradioamateur group in the nearest ten years. Precisely any other matter in the universe is not capable of hijacking high-energy gammas than a particularly intelligently-tailored tubular sufficiently long superconducting exciton polariton nanomaterial and only if it is directed accurately to the direction of radiation. It is possible to collect the used modulation/polarization or something for which the information can be written on the pipe path. A perfect device for intelligent breeds to communicate. Supposedly, as a quantum phenomenon, even the transmitting end can immediately be informed when the message is opened, or by imposing the second half of the pair, can change the state that is hereby communicated in real time, or the receiving end determines the shape whereby the transmitter's head, possibly already hundreds of years old, The state changes its shape and we can tell them something above the stars. in real-time.

The photon from the radiation element to the nanomaterial and the light surface wave of the light generated from the chamber opening proceeds into the chamber along the spirally expandable cone path and if its energy is close to the characteristic frequency of the exciton vibration chambers in the chamber walls, it pingpong the exciton cavities until its energy is completely absorbed to their vibration energy. Photon naturally needs to be produced with a sufficient amount of 100% efficiency for half a million 0.78 Mev triggering, surely more considering efficiencies.

Similarly, a built-in nanoscale gamma laser is a very powerful and accurate device for microscopically small machining. For Nanorobot it is a great tool for performing material removal or connecting operations in very small spaces.

Maximum power of the method in the volume unit. Fusion power is limited by the warming of the material, and the change of matter by diffusion, etc. Possibly the shape of the back wall may have a small opening and the pressure difference could carry the reactant material. The aperture can be formed as a result of the triggering of a few unreacted, triggered energy storage (in vacuum). When the energies of the shots touch the shape of the back wall, cut them into the hole.

The process of producing an efficacious matrix may include a vacuum phase without a reactant material to form only moderate energy levels which are discharged as a coherent back wall with a laser-like X-ray gamma discharge that cuts the opening and thus improves substance turnover in the chamber during use. Especially if the shapes are on the surface of the plate-like body and behind the plate there is the pressure of the gaseous material, it is possible to obtain the microholes made by it only in the effective shapes it becomes a beam and a hole, the other does not, so does not make unnecessary holes. This way, one can easily prove the phenomenon. According to the invention, the formation and operation of a low-power laser device, by virtue of the scale of the invention, causes the opening to be drilled into the back wall of the form. By keeping the plate in a vacuum and by conducting suitable electromagnetic radiation, the laser devices on the plate can be operated and formed holes. If the hole leads through the plate material to the gas pressure chamber, the plate leaks through the gas which can be measured and thus the phenomenon proves. Engraving of metal should be possible at much lower energy levels than fusion reactions are needed. The vaporised material leaving the runner must naturally not cause substantial interference with the operation of the nano laser chambers.

Next, I will briefly describe the manufacturing and properties of certain embodiments of nickel. Take nickel, for example, a micropowder 10 um grainsize. Microcrystalline nickel plate or yarn may also be used. Big grain based nickel produces a bad/uncertain result. Apply nickel surface approx. (3)4-5 um depth to fine-grained nickel oxide, eg 2 h 250 C in air by heating or 5 min at 800 C. Thereafter, about 2-3 h of 250 C is reduced in the hydrogen gas to form about 50-200 nm diameter cavities up to the surface of the oxidized nickel, which are slightly suppressed by the initial part and with a circular bottom form. All nickel oxide has not yet been reduced since less than 500 C by reducing the reaction dynamics is slow and incomplete. Thereafter, reduction is continued by heating nickel over 800 C preferably with 1000 C and hydrogen as a reducing agent, where appropriate under reduced pressure. The pressure can be somewhat affected by the size of the shapes. Over 800 C reduction produces a nickel layer containing fine structure cavity/spongy formations from the end of the oxide layer, i.e., small, approximately 1-15 nm hollow structures formed as resonator chambers around the larger cavities formed in the first reduction stage. Another way of making one embodiment is to choose a suitable fiber with a diameter of 100-200 nm, with a length of e.g. 10 um, which can be longer as long as it is predominantly straight. The material may be a magnesium-based ceramic insulating wool, e.g. a sol-gel process. The fibers are carefully coated with finely ground green nickel oxide, eg with in a ball mill week milled oxide, which is mixed with the solvents, the fibers are painted by dipping the solvent-oxide, it is an advantage that, when dried, at least one point is formed in which the oxide is not in the region of about 100 nm, e.g. so that they are somewhat pressed/moved in the long fiber wool and the fibrous assembly so that the longer fibers wipe off a little oxide. Thereafter, the fibers are reduced at about 800° C. in hydrogen gas (in the dark), whereby a nickel having a cavity-like structure with an aperture (s) of about 100-200 nm is formed on the fibers from which the fiber material is present without a nickel layer.

In Opal (mineral), it may be possible to drill holes that are surrounded by crystal-formed microspheres and thus act as some kind of device, neither the vessel will lead to electricity that can degrade the properties. Grain size varies at least within the range of 0.76-23 nm depending on the type of mineral.

The production of a suitable vibration chambers can be done with few nanometer microspheres that adhere to one another in the liquid under the influence of capillary forces. Fibers can be added to the microspheres. The magnet/electric field can hold the fibers upright and then electrolytically fill the end with nickel or some other suitable metal. Microspheres can have a better dielectricity than the empty space, in the fiber can generated a sufficiently strong discharge to hollow it, or it can be chemically etched off or leave the fiber off and drill a suitable hole with a particle beam/laser into a suitable vibration chamber matrix.

The Theory/Level of Knowledge of the Nanoscience Material Structure, an Explanation of what is Happening in Nanoscale Material:

It is known that if the nickel plate has a cavity of about 100-200 nm diameter, the light on the plate can be absorbed into the cavity and generate a phenomenon known as the surface plasmon polation, i.e. the second word to become the surface wave of the electromagnetic radiation. If the depth of the cavity is far greater than the wavelength, the surface wave starts to rotate the inner surface of the cavity from the spiral line and changes through the reflection and the like to form a standing wave according to the wavelength determined by the depth of the cavity, although the specific frequency of the matter also affects.

Such a situation is also known from the tecnology that there is a flat metal plate in which small spherical cavities open onto the surface of the plate, a cavity diameter of e.g. 1/10 used wavelength, red light is passed to the edge of the plate which is converted to light surface wave, surface waves proceed to propagate on plate, collide and interfer with cavities With the energy absorbed into the cavities and the change of the oscillation frequency same of all cavities typically the same as the characteristic vibration frequency (loss of minimal), energy is stored in all cavities

The plate is swept with blue light, resulting disturbance in vibration and all cavities simultaneously emitting monochromatic photons. Similar cavity plates can also be excited with electrons in addition to photons.

It is also known in the thecnology that the magnetic fields are influenced, for example, in similar vibration phenomena within the crystal, Summing up the energy of two excitons as a higher frequency excitons, it is also known for the unconventional surface photonic phenomena radiating to the original stimulating photon source at a double frequency. The effect of moderate magnetic field on exiton is also known, increasing vibration energy by magnet.

Further, the technique is familiar with some experimental low power plasmon laser shapes constructed in 2D plane. Plasmon polariton systems have also been found to form Bose-Einstein condensate at room temperature. By means of these known phenomena it is possible to explain what happens inside the nanomaterial described in this invention. The present invention has a sufficiently long tubular shape substantially enclosed by the structure of small vibration chambers so large that it can store energy in total in the vibration chambers in forth of hundreds of thousands of electron volts. The small physical size of the vibration chambers is essential because the energy stored in the individual chamber is higher, the physically small chambers still fit more than one volume unit from which energy benefits are achieved, but the condensate of bose-einstein is also more easily formed.

Naturally, the reduction has a steep lower limit, whereby the oscillation is no longer developed, and the surface traveling energy-carrying surface wave of the light does not interfere with the exciton oscillation form by energy transferring it. The energy of a single exciton can be calculated through the capacitance of the form. The exciton binding energies in the molecules have been determined to be 4 ev, “exciton cavity” also said to have a “giant oscillation strength”. Some measurements in nickel have up to 5.9 ev energies. In the studies, vibration chamber sizes commonly used in the range of 200 to 600 nm are commonly used, there are no published studies for a hundred times smaller chamber, possibly due to manufacturing-related problems.

The larger about 200 nm forms studied are able to form a bose-einstein condensate.

The more obviously the smaller the form is able to do it more effectively. The BSE condensate is known to be susceptible to magnetic fields and capable of simultaneously discharging, i.e., the tubular chamber form surrounded by particularly small exciton oscillation forms a highly efficient and very short pulse laser style device that may still have a “blue shift” characteristic of vibration energy, i.e., capable of raising the quantum energy of the radiated coherent quantum To a level of electromagnetic radiation whose wavelength is shorter than the wavelength of the energy carried radiation. The wavelength may even decrease to the level of the gamma waves and thereby possess quantum energy of hundreds of thousands of electron volts, at least the pulse time of this device is extreame short and pulse energy is hundreds of thousands electron volts. The release of the energy state of such a microlaser can also be triggered by the single quantum of short-wavelengt electromagnetic radiation in the tubular form, the inherent frequency of the material at a double frequency, or the still more energetic photon quantum (blue light, UV radiation, etc.) is substantially offset with the vibration frequency in the exciton storage modes. when energy storage can uncharge to the triggered wave strengthening it. BSE condensation state storage form may be completely simultaneously discharged, as the energy of the triggering/discharging wave increases to hundreds of thousands, millions of electronvolts. For maximal discharge energy level I have not yet been able to determine the upper limit, Bose-einstein condensate may set its own limits, on the other hand, the excitons does not necessarily have to be in the bose state for the operation of the device, the physical size of the required tube form sets its own boundaries or the tubular form opening end size for generating light surface wave and photon form light mutually interaction set the limits, being about ⅙-⅓ of the energy-carrying light wavelength. The maximum size of the opening is influenced by the maximum diameter of the tubular form through which the amount of storage forms that can be occupied by the surface. On the other hand, in addition to the diameter of the opening, there is no other limitation, the surface wave of the light can proceed along the surface and the structure may be extend considerably larger. The length may be considerably longer than the example interval of max. 10 um. There is also no limitation on the number of openings responsive to these photons that can be located almost anywhere in the tubular shape and may be advantageous that they are in the correct ratio/spacing, so that more than one number of photons can move more rapidly inside the tube form to grow energy faster. It may be that the tube shape can be closed at both ends if only a magnetic triggering is used and the reactive material is exchanged via other openings. Thus, the diameter of the tubular form can grow somewhat greater than about ⅓ of the wavelength and the growth of the diameter may be advantageous if high energies are to be sought.

The interaction between the excitons can also transfer energy to some distance so that the cavity form that is connected through the forms through the other cavity or form capable of interacting with photons can move energy around this unobstructed tubular form. The tube form can also be surrounded by other similar tubular forms interacting with one another and triggering the simultaneous discharge of energy or only a delay of the speed of light velocity.

The Panderomotive force, together with the capillary forces, drives reactive material at the recesses at the ends of the tubes, in which the laser becomes very powerful and short-term electromagnetic radiation pulse hits and can produce nuclear reactions in the material. If the shape is open at its ends, the generated laser pulse may naturally be directed by some other elsewhere to be utilized. If the energy of the pulse exceeds the amount of energy needed to create a particle pair, 1 Mev can produce an electron positron pair if the shape is capable of producing approximately two thousandfold of the amount of energy that can be generated by heavier particles, which can provide longer-lasting material. Even with smaller energies, nuclear reactions can be made.

Thus, by means of the aforementioned methods, can built a device that utilizes electromagnetic radiation from ambient temperature cabable raise the energy of the quantum, for example in the area of visible light, from which further electromagnetic radiation of higher energy and ultimately even permanent material can still be produced.

The vibration cavities on the inner walls of the tubular form react with the surface wave of light passing through the tube form surface wave and the surface wave energy is transferred to the oscillating shapes.

It is known that these exciton oscillations can be excited in many different ways. Let me introduce this previously unknown borderline, that is, electromagnetic radiation (gamma radiation) from an atomic reaction may tune a number of excitons and run away at the same time. Thus, the need for a radiation shield is avoided and the excitation energy necessary for the reaction is obtained from the gamma radiation of the previous reactions. This behavior can also explain the use of strange absent radiation from known atomic reactions as such in the above-described environment, and the principle of the newly introduced nanopowder-based radiation shields—the material contains a large number of tubular shapes with vibration chambers like in this invention, the gamma radiation lost in the tubular form loses its energy into the vibration chambers and vibration becomes heat in substantially thin layers versus conventional radiation shields.

If the form of this type of tubing is substantially effective and the radiation intensity is sufficiently large, the accumulated energy may be converted to some material, or if the tubular forms are low energy and directed, the accumulated energy may be discharged even if laser radiation which is used elsewhere. It is also important to remember the effect of vacuum energy on base energy/radiation, that is, a suitable chamber size eg at the wavelength of the proton quantum wave produces/Particles if enough energy is provided to an empty chamber. If there is enough adjacent chamber adjacent to the corresponding antiparticle and both chambers will receive enough energy from the same source. In order to make particles, they should appear in this world as well.

Even when leaving the reaction, the charged particles with a moving velocity can also pass energy through the tube chamber to the exciton vibration modes, so gamma radiation is not the only reaction product capable of transmitting energy for use in the next cycle but alpha and beta radiation as well. Naturally, energy can be transfer from the adjacent exciton chambers same levelling if they are connected to each other.

The interaction between the vibration modes of the excitons through the surface wave and the summing of the quantum energies. It may be possible to make a structure in which the energy of the excitons adds up and affects the surface wave of electromagnetic radiation with another physically smaller exciton vibration form where the energy is summed up again and further affects the third even smaller and so on. Long-wave electromagnetic radiation does not interact with a physically too small exciton vibration chamber, but the summed energy exciton can form a surface wave that will then affect the next smaller excitons. Excition energy can also be divided into parts and the device can also be used in the other direction. That is shape, a funnel-like exciton vibration chambers in which the size of the vibration chambers is suitably reduced as the diameter of the shape decreases may be able to convert the low frequency electromagnetic radiation to higher frequencies or vice versa. Funnel shape may have further filtering structures for the steps to prevent misaligned surface waves from advancing to the wrong layer, the material used may vary between the layers by selecting a substantially lossless material for each layer at a suitable specific frequency. This device is incompatible with some of the rules of physics, but because it is known in the exciton-polariton systems to doubling the frequency and halving the frequency, the construction of the above-described device is possible. Energy will not disappear and it it will not be more. The magnetic fields have an impact on the above device.

Such a device would create a passive night vision “night vision glasses” if the Thz area were to become visible in the area of visible light. Uses are naturally quite numerous cases, Beach goggles that change nearby infrared visible, at least a huge selling bet judging the characteristics of some camcorders.

In manfacturing the safe surrounding material by non-selective methods, the surrounding material containing countless forms formed at different excitation frequencies and taking into account changes in the shape of the heat movement and hence the excitation frequency may be subjected to heating the material containing the mixed frequency patterns above the normal desired operating temperature, The electromagnetic radiation pulse, the magnetic field, causes a lot of reaction shortly that at this temperature/radiation wavelength the active sites are locally destroyed by the reaction heat/radiation as the rest of the points remain unchanged. The procedure can be repeated at different wavelengths and temperatures of the radiation and thus obtaining the peripheral material in which the reaction rate is a negative temperature coefficient produces an surrounding material that behaves with substantially more accurate properties of the mixed material.

Pressure

Magnetic Field Alignment

3 Electromagnetic Radiation-Emitting Radiation Element

In order to provide reactions and/or to initiate reaction chains, it is preferable to transmit electromagnetic radiation in the preferred frequency range of the reactions/nanomaterials to the structures in the vicinity of the reacting material with sufficient intensity, to collect the standing wave forms and the energy stored in it, or to store exciton forms of nanomaterials. In the literature, the oscillation frequency of the hydrogen molecule is about 100 Thz, located in the infrared spectrum of the spectrum. Multiple multiplexes in the base vibration can also be useful methods for hydrogen, such as 550-800 nm range. There are some published reports where the reactions have been described at the starting temperature of about 700 C, at this temperature the maximum magnitudes of the quantums emitted by the material rise to 550-800 nm. A glowing piece transmits electromagnetic radiation whose amount of radiation and frequency distribution depend on the temperature of the body. If you want the glowing body to produce 100 Thz of energy as efficiently as possible, the body temperature must be approximately 2100K. Naturally the other cooling ways of a glowing piece must be prevented in an energy-efficient method. The 2100K temperature range generates a lot of other radiation frequencies around 100 Thz. The 200 Thz energy-efficient glowing body should be at 4150K. Thus, the glowing body is not particularly energy efficient to produce a narrow spectral range, although it is sufficiently effective for use in the method disclosed in the invention. The maximum energy of the quantums of the frequency range transmitted by the glowing body also depends on the temperature of the body. A more energy-efficient way is to use wavelengths produced by fluorescents and or optical semiconductors. Naturally, each reacting material has its own oscillating frequencies for which the frequency of the radiating element is to be matched in the energy-efficient process. In known systems where suspected or suspected occurrence of atomic reactions is used a heated micro-powder, the heated powder material simultaneously forms a radiation element, and the heated reactant material acts as a radiation element, and the reactive material container and/or micropowder transmit substantial amounts of wavelength required for the reaction. It has also been shown embodiments wherein the nickel wire, which acts as a heating element, apparently contains the necessary structures for standing waves. The nature/causes of the phenomenon can not be explained in any of the publications as described in this method. All known reaction environments produce electromagnetic radiation in their operating state and the transmitting elements therein react with heat as a consequence of the reaction of the material to be changed and are thus strongly positively coupled to the resulting energy of the reaction, most often to heat or heat-generating radiation. In known systems, the reactions heat up the material, which then transmits more electromagnetic radiation that accelerates the reaction. This results in a very tricky reaction that, as it progresses, seeks to escape control by uncontrolled heating, often leading to the destruction of the microstructures necessary for the reaction. Uncontrolled behavior greatly impedes the growth of the amount of reactive material to obtain a larger unit size, further uncontrolled behavior in a process where changes in the atomic level can occur is a very high health risk. A somewhat cooler environment for the reaction is beneficial. For the durability of the materials, the operating temperature below 800 C is advantageous if operated under temperatures of less than 500 C, the amount of radiation emitted by the materials of 100 Thz or its multiples such as 200 Thz remains very low, i.e. better controllability. Naturally, the method should attempt to utilize the dimensions/forms of the material in the reacting material and use resonance frequencies outside the top of the radiation spectrum at the ambient temperature of the reaction, either above well above, whereby the surrounding material that changes its shape and the reaction stops without causing danger to the environment can be used Most preferably slightly larger forms, which are located on the smaller side of the spectrum peak, whereby, when the material is heated,

a negative temperature coefficient is formed thereby the method is self limiting. Naturally, the preferred temperature coefficient depends on whether the reaction of the reacting material is heat-generating or consuming. Further, it is interesting to note that it is possible to produce a form of surrounding material that acts as a collector of electromagnetic radiation in a 20 Thz region that the planet's ambient temperature can produce quite large amounts by collecting it by radiation and finding at any suitable vibration atomic-level reaction that consumes energy by all side reactions. It is possible to produce material from an environment of low heat energy. Consuming the heat of the environment. This should not be possible according to the current physics, but if in the future experiments it becomes clear that using the presented method can be circumvented within the scope of the present invention. Generating positron+electron pair should be possible at 1 Mev at energy level, with their separation, collecting should be possible on the basis of current technology, utilizing this invention. They can be used to produce high-energy eruptions from which modern physics is familiar with the reactions in which a longer cohesive material can be produced. An environmental wasteheat functional antimaterial generator that can be used to cool the environment, for example as a cooling device for a research robot that penetrates a hot planet, perhaps as a cooling apparatus for a research robot that penetrates the star.

Naturally the surrounding material of the reacting material should be a good electrical conductor, it can be made from superconductors and obtains essentially lossless environments whereby the energies of substantially large standing waveforms can be accumulated in order to produce larger particles. What is the upper limit, it can be larger than the most effective human-built particle accelerator. A method for generating large particle particles by using fine-grained low loss, particularly superconducting material and standing wave storage forms, by transferring electromagnetic radiation to a substantially low electromagnetic radiation source of quantum energy, a reaction at a preferred vibration frequency, a magnetic/electric field by controlling the reaction. Nanostructured essentially low-loss electrical/electromagnetic vibration circuit whose vibration energy is controlled by magnetic/electric fields/electromagnetic radiation in a controlled manner to individual atoms or vacuum parts within a particularly short period of time to produce atomic reactions and/or matter. One part of the oscillation circuit may contain a substantial narrowing/stencil that compresses the energy passing through the vibration circuit to a particularly high energy condensation.

The narrowing can be produced by material, electric/magnetic fields/electromagnetic radiation/particle radiation/material by slowing down electromagnetic radiation to get it bend, by reflection. The narrowing is advantageous for the position of the standing wave energy maxim. The energy can be so large that it gives the space known as a vacuum unstable in order to produce particle pairs apparently from scratch. Changing energy to material can still be considered, and to note that if energy is transformed into matter, matter moves gravity into the universe as a gravitational force, a large transformation of energy into matter, can strengthen the effects produced by gravity in the universe and thus in extreme cases if energy is enough and the method is carried out throughout the universe. To stop the accelerating expansion of the universe. Especially research for the methods by which the energy of neutrinos, dark matter, is harnessed for use. Of course, the possibilities of mankind are very limited in this area, because the universe's accelerating expansion, which we are subjected to the light velocity constrained bubble of the universe, now only accounts for only about 5% of its total mass, so hopefully or to consider the age of the universe it is likely that the seed of life has sown very versatile throughout the universe By the earliest breeds, and we just have to take our part in our bubble, when we meet them from time to time, or if we do not do our job, our bubble blows into the endless space of the universe and the empty, cold/energy weakness of all matter eventually falling into empty space without having to return to the intelligent sister And to the brothers, possibly starting and deciding once again to do so again. We have nothing else against the destruction than knowledge and intelligence, the time is against us, the most powerful, short-lived destructive power the stupidity is over. Life is the information processing algorithm that inevitably continues to produce intelligence if stupidity does not destroy life prematurely. You exist because the chain of life is unbroken, make sure it is also unbroken after you. Knowledge is the greatest of magic powers.

Naturally, the implementation of the method is more energy efficient, the more specific the wavelengths are produced, the unnecessary output is produced as little as possible, the produced electromagnetic radiation is fed as effectively as possible to the reactant material. Production of electromagnetic radiation. The electromagnetic radiation generating devices traditionally have been based on radiation emitted by the glowing body. This radiation has a broad spectrum and the energy of its largest quantum, and the wavelength range of the highest radiation power of the radiation depends on the temperature of the glowing body with known equations and emission coefficients.

The most relevant material of the method and at least the most abundant material in the universe at this time, that is, the simplest element, The one favorable vibration frequency for the most simple isotopic hydrogen is approximately 100 Thz near which the electromagnetic radiation is located in the infrared region. The production of this radiation frequency by an incandescent piece takes place most efficiently when the body temperature is in the 2000-2200K range. The frequency can be transformed into the energy of an individual quantum by the formula E=f*h, where f frequency and h are known constant of the planc, with a aproximate value of 0.0000000000000414 ev/s, that is 100 Thz electromagnetic radiation, one quantum energy of about 0.414 ev and wavelength about 0.0000014 m. In the method, frequency ranges outside the effective relatively narrow vibration paths of the material are disadvantageous to the energy efficiency of the method. Thus, the radiative element transmitting a large spectrum region is not as energy efficient as it is, however, a usable simple implementation in the method.

Reaction outputs from a reactant material such as heat and heat-emitting radiation, when absorbed into the radiation element, cause the glowing body to emit more electromagnetic radiation, the heating of the transmitting radiation element, and hence the rise in radiation power, further shifting the radiation spectrum to the more powerful region. The radiation element(s) must be separated from the effects of the reaction products so that the reaction can be controlled.

The radiation element type can also be only limited wavelength sending, such as an optical semiconductor component, a magnetron-type wave source, or a chemical molecule that unload its excitation state, titanium oxide-carbide silicon dioxide-based materials that are widely known in the art. Feeding energy into a radiation element can be based on radiation, electrical current, mechanical friction, including high frequency vibration friction, chemical reaction, and heat. An elliptical reflector can be used to collect, for example, sunlight and lead it to a nanomaterial positioned at the aforementioned stylized focal point and to get a nanomaterial to transmit coherent electromagnetic radiation which can be substantially more easily led into corridors excavated in rock caverns, for example for grov plants. Caves can be protected from cold weather during the winter season, or from inadequate atmospheres/radiation in other celestial bodies. It can also work in space stations.

4 Reflector

The energy fed to the radiation element for the efficiency of the energy economy and the methodology must be as close as possible to the most lossless material in the wavelength range useful in the wavelength range. The electromagnetic photons emitting radiant elements in several directions may be directed to the surrounding material of the reactant, if necessary through the surrounding container, using reflective and/or folding structures. Structures on electromagnetic radiation transmitted on the transmission path from the radiation element can be used to remove unnecessary frequencies, reduce filtration, convert the fluorescents to more useful frequencies, and/or unnecessary frequencies can also be reflected back into the radiation element where they can turn back to heat and return to unnecessary radiation frequencies to the radiation element energy. Of course, the permeability of the material of the reactant element that reacts to the electromagnetic radiation pathway is, to caused a minimum loss of useful radiation in the reaction.

In a simple embodiment of the method, the radiation emitted by the radiation element may be centrally arranged in elliptical mirror form by positioning the elliptical tube reflector at focal points, a material that is responsive to one another or to another in the case of a multi-elliptical reflector, the radiation element. More complex centralizing systems including mirrors, lenses, wavelengths, multi-fold systems can be utilized in the method. In order to control the reaction, if the radiation element itself is not readily controllable, for example due to thermal mass, a material may be placed on the path of radiation that can be controlled by passing permeation/reflection/decay, thereby controlling the energy transported by electromagnetic radiation to the reactant material, achieving faster controllability.

5. Sufficient Amount of Energy for Reacting Material

Several consecutive low energy quantizes within a sufficiently short period of time during the resonance time—the correct frequency. Or, and a nanomaterial form of surrounding material that stores through the light surface waves the amount of energy required for the numerous plasmon / exciton forms in the reaction and triggers it as a coherent pulse to reacting material. From a remote perspective, the process looks the same—the energy is stored and released during a particularly short period of reacting material.

6. Utilization of the Method

For example, the method can be used to transform the most common in universe and simplest elementary hydrogen as a slightly heavier deuterium, which can be further converted into the heavier helium as the heavier body, or hydrogen/deuterium can be reacted with heavier isotopes, eg iron and obtaining more valuable nickel and thermal energy. Lithium, magnesium, reaching longer reaction chains or heavy elements such as lead bismuth disintegrating, for example, as precious metals in an electronegative surrounding material. Processes often produce a large amount of thermal energy directly or indirectly when the radiation is absorbed in a material absorbing the outside of the reactor tank. Heat energy can be utilized, for example, by using thermal power plants or heat-based power plants, industrial processes as a power source, thus achieving significant cost savings for existing fossil fuel-based systems for fuel procurement, transportation, air pollution, waste disposal, nuclear fuel production and waste fuel problems, for eg transformed material eg helium has industrial value. By way of example, by the method of the invention, it is also possible to utilize the atomic reaction between proton and lithium 7 to produce helium ions with high kinetic velocity, as reserved particles they can be braked in the electric field and collect their kinetic energy as a high voltage electrical charge that can be used to supply electrical energy to a vehicle, industrial plant or/To the power grid, without the efficiency constraints of thermal power machines and the heavy complicated current structure. These embodiments are just examples and it is clear that the method of the invention can be utilized in more diverse places in the technology where only heat, electricity or/and lack of elemental which is needed.

Further, the industrial plant, the power plant, and the device to move the unit will benefit particularly from existing fossil or conventional nuclear fuel compared with fuel logistics simplification and reduced material volume. However, certain nuclear reactivity chains that produce particularly low harmful radiation can be used in the process, whereby the mass and size of the radiation shield required for safe use, The radiation shielding material may also be manufactured as described in the method to include countless exciton vibration chambers and to allow it to absorb gamma radiation in a particularly effective way compared with conventional radiation shields

For objects using the thermal power and/or thermoelectric generator included in the process, or electrical energy from the braking of charged particles in an electric field, performance levels that are not currently possible can be achieved. For example, it is possible to manufacture a ship or an airplane capable of operating continuously for a number of years with a small fuel reserve that is essential small to the mass. Objects with fuel refill are particularly difficult, for example, space orbiting can achieve special advantages and places/speeds that are currently not possible. Thus, the thermal power plant utilizing the method, including a cold-producing thermal power machine, even without moving parts, is particularly progressive compared to the current state of the art. For example, replacing the fossil fuel burning element of a current gas turbine with the container of the process and the associated heat-producing adsorbent can achieve a thousand times saves the amount of fuel mass and the purchase price. Naturally, an even more efficient turbine-powered thermal power machine can easily be designed with fossil-based old blank is not particularly good since the turbine side is designed to work with combustion gases where the temperature/molar ratios do not exactly match the design parameters if the device no longer burns fossil. If this kind of gas turbine is connected to an electric generator and an electric generator to an electricity grid, considering that at current fossil prices, the gas turbine is not competitive in generating base energy, it will turn out to be particularly profitable if the fuel cost of the turbine machine drops to one thousandths. It is also possible to make closed circuit devices, for example, with supercritical carbon dioxide, and thus achieve high transformation efficiency in a closed and physically particularly compact device.

7 The Necessary Ways to Keep the Method Running Uninterrupted

Naturally transformable matter is transformed into an altered substance so that the atomic reactions can last longer than the dosage of the substance to be modified in the container is enough to replace the container in a container with more abundant material and surrounding material. Changing the containers by moving them can be difficult in some applications, the problem can be solved by connecting the container to another container from which the material to be changed and, where appropriate, the surrounding material to the container is moved. The method provides an advantage of the arrangement whereby the container is emptied by connecting it to a third container to which the modified material is transferred, if necessary the applied surrounding material. If necessary, the container can be arbitrarily connected to many other containers and transport the material to or from them. The container can be placed inside a second or several containers and these containers connect to other containers in an arbitrary manner to transport the material/heat/electricity / particles. The container can also be placed inside the fourth container, also with other containers Surrounding containers can be countless, one of the very often necessary containers designed to protect the environment of the radiation released from the reactions, particles. Energy is fed into the radiation element, the containers can penetrate the necessary electrical wires, pipes .

8 Control System

In a simple system, it will be accomplished by adjusting the power transmitted by the radiation element and, if necessary, by controlling the radiation power in the different frequency ranges. The magnetic field through the reactor tank can also be modified as a control operation, e.g. by adjusting the magnetic field fluctuation frequency. The amount/type of material to be changed can be controlled, for example by changing the operating pressure of the gases, the temperature can be controlled by cooling/heating. The control parameter can be used to utilize a material outside the reaction container that is absorbing by the radiation emitted, the magnitude of electric potential between the charged radiation receiving structure and the reactor container.

Background: For decades, fusion reactions have been reported to occur in cold conditions. In the 21st century several patents have been left out of fusion reactions in relatively cold conditions fusion reactions between lithium and other electronegative alkaline and alkaline earth metals as well as medium-heavy isotopes (Ni, Pd) between different isotopes of hydrogen. The most famous of these is the Andrea Ross E-Cat reactor. In this environment, isotope changes have been observed, Consisting of gamma, alpha, beta and neutron radiation. Radiation has also been detected in the E-Cat environment-specific experiments. There are many variations of the E-Cat environment. Most commonly, they are composed of lithium aluminum hydride (LiAlH) fuel mixed with fine nickel powder that has been pre-treated or treated in the reactor itself prior to the actual heat production step. A typically known reactor consists of a heat-resistant tube (Aluminum, Mullite, Steel) around which a heating element resistance wire is wound around. A fuel dose is placed inside the tube, which is heated by directing the electric current of the resistance wire. Sometimes gaseous substances are introduced or removed from the reactor. It is also a known form in which the fuel contained in the cooled reactor is exchanged without discharging the heating element itself. Typically, the use of the reactor involves the step of keeping the reactor chamber at a temperature of about 200 to 300 C for a period of time, typically an hour or a few. Thereafter, the temperature is raised above 700 C, typically at 1200 C or a slightly higher temperature depending on the durability of the materials. Typically used Kanthal resistor wire material is rapidly destroyed at about 1400 C and reactor operation is interrupted. An embodiment is also known in which a more than one of heating elements are arranged around the reactor tube and by regulating their mutual operation, the thermal power generated by the reactor can be controlled. It is also known that variations in the electrical current can be used in the heating elements.

There are also known theories in which attempts are being made to explain events. The most comprehensive of them is “The Nature of Chemonuclear Transition, Hideetsugu Ikegami 2012”. This publication relies essentially on the Gibbs energy levels of nuclear reactions and on which energy levels/isotopes the reactions are directed. The publication will not be able to explain at the quantum level the course of reactions itself. I call that release for the forward CN theory. There are also publications of some of the CN's theorized reactions, which events are dealt with by quantum physics. Of these I mention the example of “Second Orde Stark-Effect Induced Gailitis Resonances in e+ps and p+7Li” “Chi Yu Hu and Zoltan Papp”. This publication provides quantum-based criteria for long-lasting and wide-ranging atomic/molecular vibrations that can lead to fusion reactions based on the energy generated by electromagnetic radiation. Only a few reactions have been calculated simulations/energy levels currently published based on Gailitis resonance. As such, the publications contain enough information to calculate them for other reactions if the necessary source data is available. The CN theory in the light of this invention may be partially wrong, although the chemical environment certainly contributes.

It is essential in the invention that the low energy level of a single quantum of electromagnetic radiation, i.e. generally available electromagnetic radiation, e.g. light, can be obtained energy levels in material that exceed the level of Coulomb's electrical forces and may lead to fusion of atomic nucleus or to obtain other atomic-level reactions which, when leading to nuclear fusion reactions in matter. If the quantum of absorbable electromagnetic radiation causes long-lasting oscillations at the level of the individual atoms/molecules so that the vibration has not been suppressed before the next quantums arrives at the oscillation range, these oscillations can be summed up until the energy of enough many quantums is stored in vibration, the energy level exceeds the needed level for the fusion/atomic level reactions

Or other events caused by radiation quantums which are advantageous for the above mentioned reaction. Physics in the vicinity of atomic cores knows the phenomenon of “pair production” by electromagnetic radiation, where radiation energy becomes particle and kinetic energy. Publications that indicate that more than one quantum energy can be summed up if they arrive in a sufficiently small period of time I can not find the affected area of the event, but even if it were known, no published applications for the production of nuclear reactions have been presented to the phenomenon.

Essential to successful reactions is therefore the quantums absorption of material at a sufficiently small interval of time, the thing may also be referred to as sufficient radiation pressure in this publication. The invention consists of a material/structure that emits electromagnetic radiation quantums, called it as an radiator, and a material that receives the aforementioned radiation quantums. It is an advantage of the operation of the invention that the radiation generated by the radiator is fed as efficiently as possible to the receiving material, for example, using concentrating reflective structures, or/and electromagnetic radiation-folding structures such as lenses. In the quantum receiving environment, there may be microscopic structures that strengthen, conduct and direct radiation quantums to the desired material units. The microscopic structures may be shaped so as to particularly efficiently receive the desired radiation, structures may also be for a variety of different levels of radiation, each being advantageous for the reactions of any of the reaction events/to many different closely related substances. The surrounding material of the receiving material may also be so shaped that it scatter/reflects/passes the incoming quantum radiation to the reverse side of the inlet direction, thereby enabling reactions to occur from the surface layer in deeper into the surrounding material.

The radiation quantum sending material, which can be referred to further from here as a radiator, around may have structures that by reflecting/scattering collect and direct the generated radiation towards the material to be reacted. Several radiators may be used to produce higher radiation pressure to produce different types of radiation, to control the rate and speed of reactions and to control the reaction sites. The shape or reflection of the radiator can be changed during operation. There may be a set of materials around the radiator(s) or the path of the quantum beams that suck in the frequency ranges of radiation that are undesirable from the reactions, if necessary, by changing them to other radiation, shifts other that are more favorable to the reactions or simply removing them from the radiation to be applied. The material in the pathway can also pass/filter/change the desired radiation pattern and return by reflecting unwanted back to the radiator. Further, a material may be placed on the path of the beams for the purpose of penetrating/converting or stopping different types of radiation, other than electromagnetic radiation, to withstand, for example, the environment relevant to the radiators or the reactant material, to not be intermingled with one another, or to other intermediate materials or the way of rays to the prevailing materialless as possible space. Further, the material placed on the path of the quantum beams may react with other types of radiation from the reactant material to form a different material, or/and to form an electric potential between the transmitting and receiving material (alpha/beta), and of course the necessary electrical conductors for utilizing this electric potential outside the entity. The radiation-absorbing material from the reactant material can also be placed on the back side of the reactant material, relative to the upstream quantum radiation, and, if necessary, isolated by one or more material layers, even so that the continuous radiation from one layer is utilized on the next layer. Further, the material layers/channels can be used outside of the entity that regulates the transport of matter/energy, while eliminating or bringing materials that are relevant to the reactions, or material, heat, electrical current, radiation-absorbing/modifying matter for radiators, so that the process can be used for as long as possible without interruption.

Quantum radiation reflection and centering structures can also be shaped so that they have smaller centralizing structures that provide the targeting of quantum beams as relatively small points of the reactant material. Such a design is advantageous especially if the radiation produced by the reactant material is to be utilized in the material through the paths of the beams and the reactant material is not or is only weakly permeable to quantum beams, it is impossible for the quantum beams permeable material to make gaps in which material which penetrates the quantum beams well, possibly passing the beam direction Thus causing quantum radiation to areas shaded by poorly permeable matter or centering them further into areas of higher radiation. The material in the direction of the incoming rays may also be shaped so that it extends over the shading material and concentrates the radiation as efficiently as permeable to the aperture. In this case, the smaller configurations in the centering/reflecting/scattering structures are not so essential for the function or can together form an optimal entity for controlling the quantum beams.

The radiator and reactive material with the surrounding materials and the rest of the surrounding material with the necessary material layers is conducive to produce a material having high reflectance in the frequency range of the quantum radiation(s) used.

For the main shape of the reflector part, it is advantageous, for example, to be elliptical; other types of radiation collecting and concentrating are, of course, possible. An elliptical shape with a radiator and a different focal point material positioned at different focal points. Elliptical shapes can also be placed in many circulating planes around a focal point containing one reactant material, placing a plurality of radiators around the focal points. In the illustrated 2D cross-section, the third dimension may be linear, in which case the reflector part, the radiator and the surrounding material as well as the necessary additional materials will in principle form a tube/tape/plate-like form in the third dimension naturally at finite length, ending and from the material, possibly including materials and/pipes. Further, if the quantum radiation is to be focused more effectively than an elliptical tubular form, the elliptical tube part can rotate around the focal point of the reacting material of the third plane so that the reflector output and the first end meet, the radiation emitted by the circular radiating part concentrates on the point surrounding material. Further, the plane formed by the circular radiating portion can be rotated about the straight line passing through the reactant material and obtaining a plurality of circular radiators each at a desired twist angle, each with its own elliptical reflector centering the radiation produced by it to the point focal point where the reactant material is located. Further, each circular radiator can be divided into an arbitrary number of radiation-transmitting points, each of the plurality of radiation-transmitting points thus formed can be drawn straight through the reactive material point by rotating the elliptical ellipse around the straight line to obtain a reflector shape that concentrates the radiation emitted by the radiator to the surrounding material. Naturally, overlapping reflector portions near the reacting material are left unstructured.

Radiation-emitting radiation elements may be different, each optimized for the desired radiated frequency range and can be used together or separately. If the reflector part is made of an electrically conductive material and the surrounding material transmits charge-carrying radiation (alpha/beta) that is absorbed into the reflector part, the reflector part may be used to block the reserved radiation by forming/generating an electromagnetic potential between the surrounding material and reflector in the formatted electrical circuit and by ensuring that the voltage Remains within the limits where the bulk of the charged radiation still reaches the conductive reflector structure. The voltage of the above-mentioned electrical circuit is derived from the outside for reuse. The electrically conductive material casing can also be located inside or outside the reflector part, naturally within the interior of the action it is advantageous to pass the desired quantum radiation as well as possible.

For the reflector section, it is advantageous to build it from a material that permeates relatively much higher energy uncharged radiation, such as gamma radiation. Outside the reflector part can be placed a very gamma/X-ray absorbing material that can be heat-insulated and utilized by the heat transfer of heat generated by the materials formed through that material through known heat-engines and directly or indirectly by thermoelectrically driving forces of chemical reactions, further utilizing heat directly or other waste heat for heating purposes. Material materials in the vicinity of the reactant material can also be used to transfer heat energy to the aforesaid utilization. The gamma radiation absorbing layer can work to protect the environment from harmful radiation. Naturally, additional layers can be added to the equipment to protect the environment from harmful radiation, as well as the necessary tools to handle the operational or spent nuclear fuel, to separate parts for removal or to be returned to the corresponding equipment. Naturally, layers can be made of the necessary material gaps from other materials to transport matter, radiation and heat.

The apparatus may also have the necessary measuring instruments to monitor the state of the reactions, as well as the necessary control devices for controlling the matter/energy streams, the computing capacity to anticipate the state of the reactions and to make adjustments based on the prediction data.

Through the reactant material, a magnetic field can be used which can be used to direct the charged radiation from the reactant material, to influence the reactions themselves in response to the reaction rate of the accelerating or slowing responses of the reactant material. Magnetic field can be produced by solid magnets or electromagnets, magnetic field strength/direction can be changed by changing the direction of electric current or by rotating a solid magnet. In addition, there may be necessary materials for transporting the magnetic field through the reactant material. Electromagnetic radiation-responsive materials can be transmitted simultaneously with the magnetic field to transfer energy or to observe the essence of matter/energy levels. A magnet or/and an electric field can be used to hold the material in place and to carry the material. To convert energy of fast moving charged particles to electromagnetic radiation.

Utilizing such fusion reaction generating aparatus by transforming the elements into other elements by changing in the above mentioned layer of materials, changing the less prestigious elements to greater value, producing or consuming fusion or/or fission of energy from reactions or radiation types, (Including but not limited to) isotopes of uranium, thorium, lead, bismuth, and other heavy elements to produce noble metals such as palladium and gold. Also, the conversion of light isotopes to heavy isotopes with the purpose of producing energy or other unwanted isotope by producing or consuming energy.

Furthermore, with the introduction of this technology, it is expected that the use of fossil fuels and conventional nuclear power will be significantly reduced, as well as significant reductions in energy prices, the use of this type of technology in all those sites that have previously operated under the fossil or conventional nuclear energy, air, land, sea, Under the surface of the sea, in space as in the celestial bodies.

Furthermore, the introduction of the form of energy, a reliable, low-priced, small units usable unit will lead to a loss of monopoly position on electricity and heat networks, the very large-scale decentralized heat and energy production due to society's taxation, using the above-mentioned or some other kind of nuclear energy, energy production in small decentralized nuclear energy units. A nuclear reactor or a block (fusion) nuclear power plant (˜100 kw). As the price of energy is falling, the cash flow coming from it is also small, in this world it is more important to obtain raw materials by combining the aforementioned small unit with biomass processing and by requiring energy users to collect biomass for the equipment to be supplied from the hardware combination of carbon-based products in further larger units for further processing, eg carbon fibers, phenolic resins As well as fuels for applications where a small-scale fusion reactor is not practical or where material is required as a propellant, such as a rocket.

An Example of Method a Simple Demonstration Reactor

1 g finely divided nickel powder is oxidized in the atmosphere for a few hours at about 200° C. to oxidize the surface layer. Thereafter, the powder is reduced in the hydrogen gas stream for a few hours to create approximately 200-400 nm of cavitys/channels at the surface. Subsequently, the temperature of the powder is elevated to 1000 C, whereby the reduction reactions take place very quickly and produce about l0nm of size cracks in the aforementioned channels, which may lead to adjacent channels as constraints of the operations. The nickel powder is allowed to cool under hydrogen stream under non oxidative conditions.

Subsequently, lithium aluminum hydride 0.1 g in non oxidative and dry conditions is added to the nickel powder, mixed and placed in a reaction tube prepared from quartz glass in this example having a relatively good electromagnetic permeability in the broad spectrum region. To the other end of the reaction pipe is connected the hydrogen pressure supply pipe, to the other end connected to the vacuum pump and the pressure control valve.

The tube is supported on a rack surrounded by an elliptical reflector made of a thin aluminum sheet, turning it into an elliptical tube. The reaction tube is placed at one of the focal points of the elliptical reflector. The second focal point is positioned on a radiator tube, in this example, a halogen lamp tube known per se, to which an electric current is connected through a known light controller. The thermocouple is mounted on the reaction tube to observe the temperature of the outer surface of the tube.

Electricity is supplied to the radiation tube by means of a light controller by limiting it and monitoring the thermocouple voltage will keep the reaction tube at about 200° C. for about 4 hours. The internal pressure of the reaction tube is allowed to rise to approximately 2-10 bar readings, if higher the relief valve is functioning. Thereafter, the temperature of the reaction tube is raised to about 500° C. to degrade lithium aluminum hydride to lithium metal and vaporize metal lithium to the surface contour of nickel powder by introducing greater electrical energy into the radiation element which naturally warms and grows the photon energy, as the energy of the photon quantums increases. It is preferable to obtain a 2100K temperature of the radiant wire of the radiation tube because that much of the radiation spectrum is about 100 Thz at a frequency which is advantageous with the surface forms of the nickel powder 200-400 nm when they act as antenna structures of ¼ of the length of the radiation equivalent to the radiation quantums of the hydrogen molecules in the cavities hydrogen molecules were ionised/dipolized by litium metall effect they start to receive such radiation quantums. Radiation quantums, which causes them oscillations most likely to be Gailitis resonances or some other currently unknown resonance, causing the addition of radiation quantums energy to potential of millions quantum energies leading to the fusion of hydrogen molecules/atoms with each other. There is at least an observation of X-ray radiation, as well as of the warming of the reactant material, of that test reactor. The more likely it also transmits small quantities of beta radiation, of which a small part reaches the aluminum reflector and is potentially measurable as a voltage difference.

Around the test reactor, from the reaction tube at a desired distance can also be sparse wound the conductor, where by applying an alternating current can be detected by its affect the reactions. Such a embodiment is not sensitive to the like of the known E-cat embodiments for breaking the heating element by the reaction heat. The small mass of the radiant element relative to the mass of known shapes allows a faster controll to the reactor temperature. The temperatures used in the known forms up to about 1200 C only send very small amounts of the desired wavelength for the reactions. As well as the heating elements in known forms are coupled to the reactant material. So they move considerably more direct conduction heat to the reactant material which, for a long-term operation of several hundred degrees lower temperature heat would be preferable. In still known embodiments, the heat conducting connection between the heating device and the reactant mass will result in a positive temperature coefficient. Whereby reaction often tends to get out of control. Heated for as long as the surrounding material of the reactant material suffers with melting and the reaction stops/declines. The heat increase of the heating elements transports the spectrum they radiate to the reactions in a more favorable direction, boosting the reaction and heat generation. In the present invention, the heat transfer through the conduction between the radiation element and the reactant material is almost completely prevented. Thus, the heat increase of the reactant material does not engage the radiation elements as in known solutions. In the invention, the radiation elements can be considered, for example, at a temperature that more efficiently produces radiation quantums which are advantageous for the reaction, thus achieving better energy economy, also known as the COP coefficient. It is also possible in the invention to produce radiation elements that produce more energy-efficient desired wavelengths than the radiation spectrum emitted by the glowing body. It is also possible to use a variety of radiation elements at different wavelengths, each element working as efficiently as possible in its own area. One example of a known reaction is 1/1H (p, e+ve) D is claimed to have a vibration range of about 100 Thz, i.e. about 1.4 um infrared frequency range. The energy charge sent by a glowing body hit this energy area when the temperature of the glowing body is about 2100K. Of course, the temperature of about 1200° C. of known embodiments also transmits quantum radiation at this wavelength but it does not perform energy efficiently, even a small rise in temperature raises the proportion of 100 Thz radiation, as well as the amount rapidly, i.e. the risk of increased reaction rates with temperature rise is considerable. In practical experiments, a much larger amount of reactant material causes reactant material and/or melting of the reactant material. The surrounding material of the reactant material, such as nickel powder, is known as methods of generating microscopic cavities/corrosion.

It is essential for the operation of the invention that the cavities are a size class capable of receiving a favorable frequency range for the reactions and leading it to the actual reactant material in the cavities. Effectively operating frequency ranges for each of the reacting materic isotopes are numerous, hence the invention is not limited to 100 Thz and suitable microforms, but is applicable to other frequency bands and the reacting material surrounding material different size cavityforms. It should also be mentioned that the typical ¼ wavelength antenna assumption is not necessarily the only effective form of quantum radiation reception. Other ways of producing electromagnetic radiation-receiving antenna form are known in the art, some of the antennae also have a good orientation effect which may be of interest in guiding material that reacts to quantum radiation energy. In the case of the disclosed reaction, the neutral hydrogen molecule first needs to be slightly polarized, this may occur under the influence of the material around the reactant material, such as an electronegative alkali or alkaline earth metal. The non polarized molecule/atom is unable to receive quantum radiation. Proton-proton fusion is not known at the time as published gailitis resonance frequencies and there is no published information at all that this would be possible. In contrast, publications in which it is found by known physics to accommodate the temperatures shown in the invention are, instead, abundant. Currently, the frequencies of the publications are known as proton lithium frequency, but the publications do not take into account the structural size of the proton-lithium material's surrounding material and therefore why the structural size is essential relative to the frequency of the preferred quantum radiation. Other fusion possibilities or gailitis frequencies are not currently known as publishers.

As stated in the invention, the size/shape parameters of the surrounding material of the reactant material must be adapted to the wavelength of the quantum radiation required so that the surface form is capable of receiving and allocating the incoming quantum radiation to the reactant material if the reactant material is not polarized, as is typically the case, there must be a material capable of causing The required polarization so that the atom/molecule of the reactant material is capable of receiving the quantums of electromagnetic radiation, which is termed a quantum radiation in the present invention, and that the amount of incoming quantum radiation is sufficiently high so that potentially millions of quantizes will add to the single particle of the reactant material at a time in the particle impact range, allegedly extending for three decades In the larger spherical area of the volume consumed by the particle. Thus, the forms of the surrounding material need not necessarily have the nickel mentioned in the invention,

but can also be formulated from other materials capable of producing cavities/surface contours enabling the receipt of the desired frequency quantizes in which the reactant material is located with the necessary polarization causing material. The surrounding material can thus be exemplified of titanium, iron, palladium as well as other materials that are known or may be produced by the later technology/science to produce the necessary microscopic shapes with later knowledge. It may be advantageous for the surrounding material that it is made of a material that does not take part in the fusions/fission reactions, or only takes part in it as a momentary energy/particle storer, returning the energy/particles of the reacted material to be used. For known example is nickel isotope at a mass index of 62. It may also be advantageous that the surrounding material of the reactant material will change due to the responses of the reactant material, as is known to occur in the iron isotopes, as they gradually become nickel isotopes 62. Wherein the lower-quality surrounding material can be prepared by the reaction of higher quality surrounding material, or kilograms-priced considerably more valuable material, whereby the value is generated from the economic values of the product, although terms for the material/surrounding material reactions itself it is not optimal. For energy-efficient operation and particularly high energy levels, the surrounding material may be manufactured from superconducting materials.

The apparatus/method describled in the invention can be used more extensively to convert the material into the second material of isotopes. The surrounding microscopic material surrounding the reactive material under quantum radiation and controlling/receiving/scattering quantum radiation can be located in the vicinity of the less valuable material unit to be modified and the radiation (alpha/beta/neutron) from the reactant material can cause changes in the modifiable material to the desired isotopes. The matter to be changed can also be surrounded by another material, the effect of which can be changed by conventional alterna-tions, which are now considered normal, to be transformed. For example, the reactant material has been subjected to such a violent reaction that neutrons that fall into the transformable material, for example, uranium isotope 238, which is subjected to electronegativity/ionisation-causing material, is subjected to reactions occurring, causing U238 a typical fission reaction directed to precious metal isotopes Pd, Au, etc. The change reactions produce more than normal fission reactions The amount of neutrons that can be used to maintain the chain reaction in the modifiable material. In the vicinity of the material to be changed, neutron-retarding or absorbing material can be placed to adjust the reactions.

The material to be modified may also be placed in an surrounding material whose top forms are effective for receiving quantum radiation at a wavelength which is advantageous for degradation reactions. Forms of polarization may have the necessary polarization material. Such types of heavy matter isotopes to be transformed, some of the fission variants can be produced by the isotopes of the noble metals are currently known solid fuels U235, U232, Pt239, but in addition to almost all other heavy isotopes which, by known state-of-the-art technology, are unable to sustain fission chain reactions such as bismuth lead by example. If it turns out that the described device does not work, the device can be used as an exhibition item and therefore it can be utilized industrially.

### SUMMARY

According to the foregoing description, a method for producing an atomic reaction in a container that transforms the material with a second atomic reaction and whose conversion, heat, particles, neutrinos and/or electromagnetic radiation is released as a reaction product. The method includes a radiation element that is essential for the atomic reaction to transfer electromagnetic radiation to matter with quanta having less than 500 electron volts of energy. In the method, the targeting of the reaction products of the container (13) to the radiation element (12) is controlled by separating the container and the radiation element from each other.

In another method for producing atomic reactions, a coherent electromagnetic radiation pulse emitted by microstructural (5) storage forms (7) can be used to achieve the necessary energy levels for atomic reactions.

In each of the previous methods there is a shape in which the material to be transformed in the vicinity of the material to be modified has forms of electromagnetic radiation receiving shapes. The dimensions and shapes of the material in the vicinity of the material to be modified will filter, control and store standing wave electromagnetic radiation on the material at the material resonance frequency, conduct the energy of the radiation in the polarized state of the modifiable material and that the material may be of polar nature and/or polarized with molecular-level material and/or electrically charged material and/or forms and that a magnetic field can be passed through the material. Typically, if the radiator element is a laser, the instantaneous radiation power is less than 1 gigawatt.

Further, the above-mentioned methods is the form in which energy can be conduct on material to be converted at electromagnetic radiation which is frequency-selected electromagnetic radiation and conduct material an acceptable nuclear reaction resonant frequency so frequent intervals that the resonant modes have not time to discharge and the material to be transformed is polarized and/or polarized by material and/or structures and/or at the energy levels of the material to be modified to obtain level the material of the transformable atom that can be tunneled with the atom to be transformed into modified matter and/or happens other atomic level phenomena.

Further, the above methods have the form of a pathway of electromagnetic radiation prevailing between the the radiation element and material to be transformed, which comprises essentially electromagnetic radiation permeable material, a particular materialless space, and that a pathway for electromagnetic radiation to the container can be set to electromagnetic radiation concentrator to container system and/or undesirable wavelengths of the filtering system and/or radiation wavelength of the second-changing system and/or system operation is controlled.

Further, the aforementioned methods can be used to convert energy and/or element into the second element, element isotopic and/or energy and/or radiation generation.

The heat utilizing device, such as the last example heat engine or termoelectric generator, or a device utilizing radiation, or a device for moving the object, industry- or power plants, without limitting them, may include the above-mentioned device or based on any of the above-mentioned methods as a portion thereof.

Sources

Partial Source Listing, Listing is provided as a partial reference material for the application
707 March 16 11:43 0fcfd50c756a89b409000000.pdf
381 March 16 10:02 1208.3972.pdf
873 March 8 18:29 1411.1009.pdf
786 February 29 13:18 1463-1444-1-PB.pdf
2155 March 14 23:21 387840.pdf
11304 February 16 09:31 477620.pdf
2674 March 13 18:54 7 plasmons and surface plasmons.pdf
1007 March 16 15:10 a096z5p01.pdf
421 March 14 20:22 a112z242.pdf
13 March 14 22:10 abstract.pdf
541 March 16 17:22 Alodjants-Phys.RevA-2012-conical.pdf
368 March 15 01:20 AminiFthestudyof.pdf
721 March 4 10:33 atoms-04-00008-1.pdf
7 March 10 01:27 beta3.gif
2826 March 13 15:24 Day et al—Nano Letter (2015).pdf
1 March 17 18:46 exiton.txt
721 February 29 12:56 gailit.pdf
2659 February 29 13:25 JMP_2014122917120647.pdf
797 March 14 22:31 Laplace-2016-PhysRevB.93.075152.pdf
7203 March 4 11:02 Nickel Oxide Reduction by Hydrogen—Kinetics and Structural

Transformations.pdf
563 March 17 10:29 oe-14-25-11964.pdf
141 March 13 18:40 oe-14-26-13050.pdf
1664 March 13 17:24 oe-21-8-10295.pdf
4733 March 14 02:27 PhD thesis Ewold Verhagen 2010.pdf
1484 March 16 15:23 PhysRevB.91.041202.pdf
2578 March 15 00:05 Plasmon dispersion in single coaxial nanocavities—Nano Lett.pdf
587 March 16 14:58 polariton.pdf
2131 February 28 10:48 PP-26-07.PDF
2339 March 14 17:50 PRB'06_nanovoids.pdf
2121 March 17 10:18 Publisher_version-network-tarkea.pdf
1666 March 17 11:10 Publisher version (open access)-1.pdf
786 March 14 01:54 Schroeter-Dereux-PRB-2001.pdf
1615 March 9 00:31 SLAC_Workshop_Wilks_2009_Final.pdf
3095 March 13 14:52 Small_7_2341_2011.pdf
34364 March 17 14:06 Thesis-1.pdf
619 March 13 18:32 TWO-30.pdf
1079 March 14 19:03 WP_paper_final.pdf
2179 March 13 16:41 Yoon-RSTA-2014-preprintv1.pdf
4734 March 13 20:19 ZayatsPhysRep408_131_2005.pdf

Captions:

FIG. 1 number (5) describes a reactant material (M) in the form of surrounding material, which forms a length (L) to form a fit of the used wavelength of the standing wave (4) making and, when necessary, storage of the vibration chambers (7). The number (1) describes a favorable region of standing wave to guide the electromagnetic radiation quantums (2) to increase the standing wave (4) and, where appropriate, the vibration chambers (7) energy. The number (3) describes the structure by which the quantums (2) is collected and directed. The path of the waveform (4) may have an energy-intensifying narrowing (8), preferably at energy peak, where the reactive material (M) is preferably positioned. The material (M) at its location may be affected by a magnet, electric fields or electromagnetic radiation(11).

FIG. 2 shows an visible light and an electromagnetic radiation close to its frequency range, suitable for electromagnetic radiation, of an embodiment of a material structure surrounding a reactant material. (3) describes a surface form that collects and concentrates the incoming electromagnetic radiation into the surface wave of radiation, (1) describes an opening which diameter is about ⅙-⅓ from wavelength of the light/radiation used for energy, so that the light waves (2) arriving on the surface can effectively transform into the surface wave of light (4) and advance to the reaction chamber (5) along its walls, from which they are absorbed into a number of exciton vibration chambers (7) which open into the inner walls or the affected area of the reaction chamber (5). The vibration chambers (7) may be on several layers for storing a higher amount of energy. The individual reaction chamber form (5) shown by the figure may be in a plurality of surrounding material (6), crosshatching describe in a section of a larger whole. the reaction chamber surrounding exciton vibration forms (7) by the adjacent forms can be formed in the connection (10) to adjacent reaction chambers or/and the connection (9) to the surface layer in a light concentrating and trapping system for transmitting vibration energy. The reaction chamber has a reactant material (M) for which a short-term, very energetic electromagnetic radiation pulse (8) is conducted by an external trigger (11) or (2) by numerous energy storing vibrations (7) discharging.

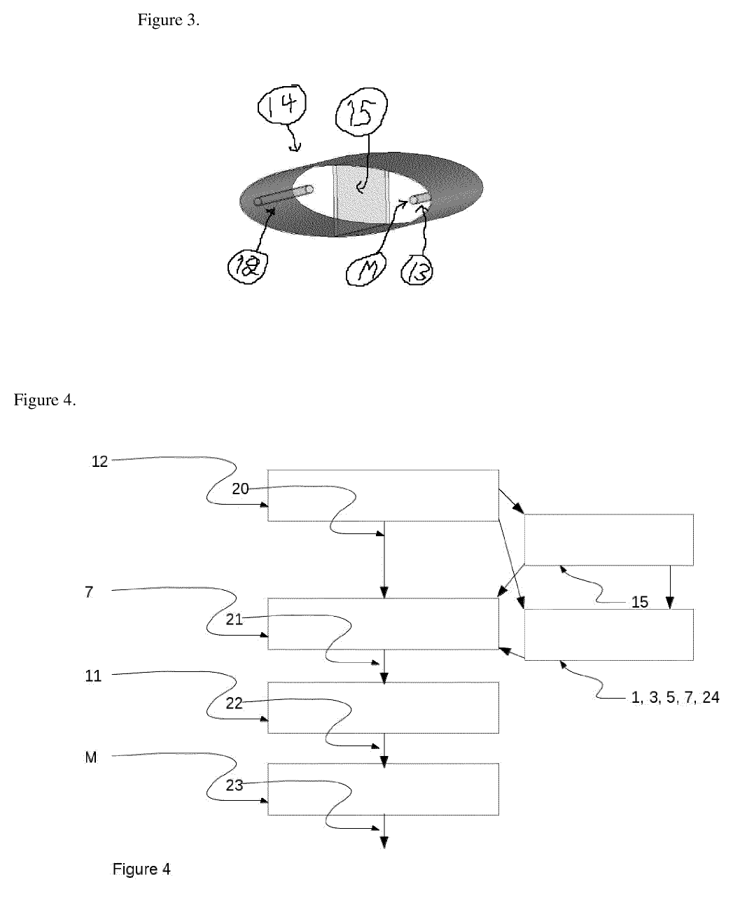

FIG. 3 shows a sectional view of a simple tubular embodiment, wherein the elliptical reflector part (14) surrounds the radiation element (12) and the container (13) containing reactant material (M). The radiation element and the container is placed in an elliptical reflector focal points. Vertical filter structure (15) has been described for the path of electromagnetic radiation emitted from the radiation element. The radiation element and the container are essentially electromagnetic radiation permeable. Outside the reflector part (14), no potential radiation-absorbing structures have been described.

### EXPLANATIONS OF THE DESCRIPTIONS USED IN THE APPLICATION

Atomic reaction refers to reactions at the nucleus core, which may include, but are not limited to, atomic nuclei fusion to a heavier atomic nucleus, degradation of atomic nucleus into two or more lighter atomic nuclei, particle pair generated near atomic nucleus, mutation of nuclei protons or neutrons, some of them leaving the nucleus. In this application, the atomic reaction does not include electron movements in the electron shell, whose reactions are characterized by a lower level of energy than the nuclear reactions.

Particles in this application refer to parts of the atom which are coming from atomic reactions. They can be proton, electron, positron, neutron, alfa particles.

Radiation in this application refers to electromagnetic radiation, neutrino radiation, particle radiation. Particle radiation consists of the aforementioned particles when they have a substantial amount of kinetic energy.

Problems in current technology. There is no known working method for producing a fusion reaction at relatively low temperatures.

There are some devices that can be expected to work utilizing the fusion-type nuclear reactions mentioned in this application (E-cat). They have the disadvantage of escaping the reactions of the device as a result the warming of the device and the consequent problem increase in unit size. There is not known energy-efficient material production method from energy at the low energy level of an individual quantum.

Container: An arbitrary form that is able to hold the matter inside or in itself.

Material to be converted: An element selected from the elemental cyclic system with a sequence number ranging from 1 to 83 can also be a blend or compound between the elements in that interval. It can also be a particle, alone or in combination with elements 1-83.

Radiation element: Electromagnetic radiation-transmitting system, such as glowing material, phosphor, optical semiconductor, low-power laser device.

Structures/Shapes/Proportions in the Vicinity of the Material to be Converted

Mainly in the visible light and adjacent area working, structure as shown in FIG. 2, which is shrunk to a smaller some parts than the light wavelength used and the phenomena occurring therein must be explained as the surface phenomena of the electric conductor and the light. The shape works as a excition energy storage that is loaded with light, electromagnetic radiation from the reaction, and or charged particles. Exciton vibration forms may possibly form a BSE condensate in some situations. The energy of a fully charged form can be discharged by varying the magnetic field, with short-wave electromagnetic radiation (UV) that is directed into the form in an electromagnetic form. When the energy is discharged it forms a very powerful and short-term coherent electromagnetic radiation pulse capable of producing the energy levels necessary for atomic reactions.

From radiation element electromagnetic radiation reflective concentrator system

1-42. (canceled)

43. A method for producing nuclear reaction, which comprises:
a) providing a long wave electromagnetic energy via an energy source;
b) charging an energy storage material with energy from said energy source;
c) releasing said energy from the energy storage material into an energy absorbing reacting material;
d) nuclearly reacting the reacting material.

44. The method of claim 43 wherein the energy source comprises a remote energy source.

45. The method of claim 43 wherein the energy source comprises an electromagnetic radiation source.

46. The method of claim 44 wherein the remote energy source comprises an electromagnetic radiation source.

47. The method of claim 43 wherein the energy storage material is connected to an energy absorbing and/or receiving structure.

48. The method of claim 44 wherein the energy storage material is connected to an energy absorbing and/or receiving structure.

49. The method of claim 47 wherein the energy absorbing and/or receiving structure comprises a superatomic scale substructures.

50. The method of claim 48 wherein the energy absorbing and/or receiving structure comprises a superatomic scale substructures.

51. The method of claim 49 wherein the superatomic scale substructure comprises an exciton polariton structure.

52. The method of claim 50 wherein the superatomic scale substructure comprises an exciton polariton structure.

53. The method claim 43 wherein the stored energy is released due to a energy releasing trigger.

54. The method of claim 53 wherein the stored energy releasing trigger is a perturbation of the energy storage material.

55. The method of claim 54 wherein the perturbation is a magnetic and/or electric field perturbation.

56. The method of claim 43 wherein the nuclear reaction is a fission reaction or a fusion reaction.

57. The method of claim 43 wherein the energy storage material is connected to an energy processing macro structure.

58. The method of claim 57 wherein the energy processing macro structure comprises an energy focusing/directing/filtering macro structure.

59. The method of claim 58 wherein the energy focusing, directing, filtering macro structure comprises a protuberance, pit, cavity or tubular structure.

60. The method of any of claim 43 wherein all or part of the energy is released as a pulse.

61. The method of claim 60 wherein the energy is in the form of long wave and/or short wave electromagnetic radiation.

62. The method of claim 61 wherein the electromagnetic radiation comprises coherent electromagnetic radiation.

63. The method of claim 43 wherein the long wave electromagnetic energy from the energy source is processed before being absorbed into the energy storage material.

64. The method of claim 63 wherein the processing comprises focusing, directing, filtering and/or converting.

65. The method of claim 64 wherein the processing is controlled.

66. The method of claim 55 wherein the processing is controlled.

67. The method of claim 43 wherein the nuclear reaction is used for generating heat, radiation and/or particles and/or transmutate materials.

68. An apparatus for producing nuclear reaction, which comprises:
a) a means for providing a long wave electromagnetic energy;
b) an energy storage material;
c) a means for triggering the release of said energy from the energy storage material;
d) an energy absorbing reacting material;

69. The apparatus according to claim 68 or utilizing the method of claim 1 further comprising a means for utilizing heat energy and/or particles and/or radiation from a nuclear reaction and/or transmutate material.

70. The apparatus of claim 68 wherein the energy source comprises a remote energy source.

71. The apparatus of claim 68 wherein the energy source comprises an electromagnetic radiation source.

72. The apparatus of claim 68 wherein the energy storage material is connected to an energy absorbing and/or receiving structure.

73. The apparatus of claim 72 wherein the energy absorbing structure comprises one or more superatomic scale substructures.

74. The apparatus of claim 73 wherein the superatomic scale substructure comprises an exciton polariton structure.

75. The apparatus of claim 68 wherein the means of triggering the release of stored energy comprises a change in magnetic and/or electric field.

76. The apparatus of claim 68 wherein the nuclear reaction is a fission reaction or a fusion reaction.

77. The apparatus of claim 68 further comprising a focusing, directing and/or filtering macrostructure.

78. The apparatus of claim 26 wherein the energy focusing/directing/filtering macro structure comprises a protrusion, pit, cavity or tubular structure.

79. The apparatus of claim 68 wherein all or part of the energy is released from the energy storage material as a pulse.

80. The apparatus of claim 37 further comprising a means for generating the energy pulse in the form of long wave and/or short wave electromagnetic radiation.

81. The apparatus of claim 80 wherein the means for generating the energy pulse of electromagnetic radiation comprises means for forming coherent electromagnetic radiation.

82. The apparatus of claim 68 further comprising means for controlling the processing.

83. The apparatus of claim 68 further comprising means to process the long wave electromagnetic energy from the energy source before reaching the energy storage material.

84. The apparatus of claim 83 wherein the processing of the long wave electromagnetic energy from the energy source comprises means for focusing, directing, filtering and/or converting.

85. The apparatus of claim 68, characterized in that the heat and/or radiation utilizing apparatus comprises a heat engine or thermoelectric generator and/or charged radiation are directly converted to electricity.

86. The apparatus utilizing method claim 43 for powering a device, moving on object and/or providing power to an energy grid, energy storage or production facility.
